(19) United States
(12) Patent Application Publication
(10) Pub. No.: US 2014/0168281 A1
(43) Pub. Date: Jun. 19, 2014

(54) METHOD OF DRIVING DISPLAY PANEL AND LIQUID CRYSTAL DISPLAY APPARATUS FOR PERFORMING THE SAME

(71) Applicant: Samsung Display Co., LTD., Yongin-City (KR)

(72) Inventors: Ik Hyun AHN, Hwaseong-si (KR); Bong-Im PARK, Asan-si (KR); Seon-Ki KIM, Anyang-si (KR); Yoon-Gu KIM, Seoul (KR); Se-Huhn HUR, Yongin-si (KR)

(73) Assignee: Samsung Display Co., LTD., Yongin-City (KR)

(21) Appl. No.: 14/028,932

(22) Filed: Sep. 17, 2013

(30) Foreign Application Priority Data
Dec. 17, 2012 (KR) 10-2012-0147360

(51) Int. Cl. G09G 3/36

(52) U.S. Cl. CPC G09G 3/3696
USPC 345/690; 345/213; 345/99

(57) ABSTRACT

A method of driving a liquid crystal display panel including a liquid crystal cell connected to a data line and a gate line includes: outputting a data signal to the data line; outputting a plurality of gate clock signals; and outputting a gate signal to the gate line based on the gate clock signals. Here, an interval between rising edges of the gate signals adjacent to each other is increased as a distance between the liquid crystal cell receiving the gate signal and a data driving part outputting the data signal increases.

This application claims priority to Korean Patent Application No. 10-2012-0147360, filed on Dec. 17, 2012 and all the benefits accruing therefrom under 35 U.S.C. §119, the content of which in its entirety is herein incorporated by reference.

### BACKGROUND

1. Field

Exemplary embodiments of the invention relate to a method of driving a liquid crystal display panel and a liquid crystal display apparatus for performing the method. More particularly, exemplary embodiments of the invention relate to a method of driving a liquid crystal display panel for enhancing a luminance of an image and a liquid crystal display apparatus for performing the method.

2. Description of the Related Art

A liquid crystal display apparatus displays images by controlling light transmittance using liquid crystals, which change transmittance of light based on electric field generated therein. A liquid crystal display apparatus typically includes a liquid crystal display panel that displays images and a backlight unit that provides light to the liquid crystal display panel. The liquid crystal display panel may include liquid crystal cells corresponding to each pixel thereof. Each of the liquid crystal cells alters light transmittance based on electric field applied to the liquid crystal cells, and transmits light provided from the backlight unit to display an image.

Each of the liquid crystal cells is applied a predetermined voltage to alter light transmittance corresponding to an image to be displayed. It may take a predetermined time for rearrangement of liquid crystals to have a desired transmittance after applying a voltage to each liquid crystal cells. The time for the rearrangement of the liquid crystal after applying the voltage is referred as to a charging time. A backlight unit may provide light to liquid crystal cells after the charging time of the liquid crystal cells is elapsed.

A time between a charging start time of the first pixel row and a charging start time of the last pixel row when pixel rows are scanned sequentially is a standard charging time of a liquid crystal panel. Thus, a time to prepare for displaying an image may be substantially the same as a standard charging time of the liquid crystals. In a conventional liquid display apparatus, the charging time of liquid crystal is typically long, and the backlight unit may provide light during a limited time, such that brightness of an image displayed thereon may be low.

### SUMMARY

Exemplary embodiments of the invention provide a method of driving a liquid crystal display panel which increases a pixel-charging rate of a pixel to enhance a luminance.

Exemplary embodiments of the invention also provide a liquid crystal display apparatus for performing the above-mentioned method.

According to an exemplary embodiment of the invention, a method of driving a liquid crystal display panel including a liquid crystal cell connected to a data line and a gate line includes: outputting a data signal to the data line; outputting a plurality of gate clock signals; and outputting a gate signal to the gate line based on the gate clock signals. Here, an interval between rising edges of the gate signals adjacent to each other is increased as a distance between the liquid crystal cell receiving the gate signal and a data driving part outputting the data signal increases.

In an exemplary embodiment, the outputting the data signal to the data line may include: outputting one of a left-eye data signal and a right-eye data signal to the data line during a first interval of a first sub-frame; outputting a refresh data signal to the data line during a second interval of the first sub-frame; outputting the remaining of the left-eye data signal and the right-eye data signal to the data line during a first interval of a second sub-frame; and outputting the refresh data signal to the data line during a second interval of the second sub-frame.

In an exemplary embodiment, a maintaining interval of the left-eye data signal may be gradually decreased as a distance between the liquid crystal cell receiving the left-eye data signal and the data driving part increases. A maintaining interval of the refresh data signal may be gradually increased as a distance between the liquid crystal cell receiving the refresh data signal and the data driving part increases.

In an exemplary embodiment, a maintaining interval of the right-eye data signal may be gradually decreased as a distance between the liquid crystal cell receiving the right-eye data signal and the data driving part increases. A maintaining interval of the refresh data signal may be gradually increased as a distance between the liquid crystal cell receiving the refresh data signal and the data driving part increases.

In an exemplary embodiment, the refresh data signal may be a black data signal or a white data signal.

In an exemplary embodiment, the outputting the data signal to the data line includes: outputting the data signal to the data line during a first interval of a first sub-frame; and outputting a refresh data signal to the data line during a second interval of the first sub-frame.

In an exemplary embodiment, a maintaining interval of the data signal may be gradually decreased as a distance between the liquid crystal cell receiving the data signal and the data driving part increases. A maintaining interval of the refresh data signal may be gradually increased as a distance between the liquid crystal cell receiving the refresh data signal and the data driving part increases.

In an exemplary embodiment, the gate clock signals may include a first gate clock signal and a second gate clock signal. In such an embodiment, a period of each of the first and second gate clock signals may include a pre-charging period and a main-charging period. In such an embodiment, a gate line corresponding to an (n−1)-th gate line may be generated based on the first gate clock signal, a gate signal corresponding to an n-th gate line may be generated based on the second gate clock signal, where n is a natural number greater than or equal to 2, and the gate signal generated based on each of the first and second gate clock signals may be transited from a low level to a high level during the pre-charging period such that a data signal corresponding to the (n−1)-th gate line may be charged in a pixel corresponding to the n-th gate line during the pre-charging period.

In an exemplary embodiment, the gate clock signals may further include a third gate clock signal. A period of the third gate clock signals may include a pre-charging period and a main-charging period. A gate signal corresponding to an (n−2)-th gate line may be generated based on the first gate clock signal. In this case, n is a natural number greater than or equal to 3. The gate signals generated based on the third gate clock signal may be transited from a low level to a high level during the pre-charging period such that a data signal corresponding to the (n−2)-th gate line is changed in a pixel corresponding to the n-th gate line during the pre-charging period.

In an exemplary embodiment, the gate clock signals may include a first gate clock signal and a second gate clock signal. In such an embodiment, a period of each of the first and second gate clock signals may include a pre-charging period and a main-charging period. In such an embodiment, a gate line corresponding to an (n−1)-th gate line may be generated based on the first gate clock signal, a gate signal corresponding to an n-th gate line may be generated based on the second gate clock signal, where n is a natural number greater than or equal to 2, and the gate signal generated based on each of the first and second gate clock signals may be transited from a low level to a high level during the pre-charging period such that a data signal corresponding to the (n−1)-th gate line may be charged in a pixel corresponding to the n-th gate line during the pre-charging period. In such an embodiment, each rising edge of the gate signals may be overshot, and each falling edge of the gate signals may be undershot.

In an exemplary embodiment, the gate clock signals may further include a third gate clock signal. A period of the third gate clock signal may include a pre-charging period and a main-charging period. A gate signal corresponding to an (n−2)-th gate line may be generated based on the third gate clock signal. In this case, n is a natural number greater than or equal to 3. The gate signals generated based on the third gate clock signal may be transited from a low level to a high level during the pre-charging period such that a data signal corresponding to the (n−2)-th gate line is changed in a pixel corresponding to the n-th gate line during the pre-charging period. Each rising edge of the gate signals may be overshot. In such an embodiment, each falling edge of the gate signals may be undershot.

According to another exemplary embodiment of the invention, a liquid crystal display apparatus includes a liquid crystal display panel, a data driving part, a gate driving part and a timing control part. The liquid crystal display panel includes a liquid crystal cell connected to a data line and a gate line. The data driving part is configured to output a data signal to the data line. The gate driving part is configured to output a gate signal to the gate line. The timing control part is configured to output a plurality of gate clock signals increasing an interval between rising edges of gate signals adjacent to each other as a distance between the liquid crystal cell receiving the gate signal and the data driving part increases to the gate driving part.

In an exemplary embodiment, the liquid crystal display panel may have a non-staggered arrangement in which pixels adjacent to each other in a column direction are connected to the same data line.

In an exemplary embodiment, the timing control part may output a first gate clock signal, a second gate clock signal and a third gate clock signal to the gate driving part. In such an embodiment, a period of each of the first to third gate clock signals may include a pre-charging period and a main-charging period. In such an embodiment, a gate signal corresponding to an (n−2)-th gate line may be generated based on the first gate clock signal, a gate line corresponding to an (n−1)-th gate line may be generated based on the second gate clock signal, a gate signal corresponding to an n-th gate line may be generated based on the third gate clock signal, where n is a natural number greater than or equal to 3, and the gate signal generated based on each of the first to third gate clock signals may be transited from a low level to a high level during the pre-charging period such that a data signal corresponding to the (n−1)-th gate line and a data signal corresponding to the (n−2)-th gate line may be charged in a pixel corresponding to the n-th gate line during the pre-charging period.

In an exemplary embodiment, each of the first to third gate clock signals may have a rising edge gradually delayed with respect to a vertical synchronization signal.

In an exemplary embodiment, the timing control part may output a first gate clock signal, a second gate clock signal and a third gate clock signal to the gate driving part. In such an embodiment, a period of each of the first to third gate clock signals may include a pre-charging period and a main-charging period. In such an embodiment, a gate signal corresponding to an (n−2)-th gate line may be generated based on the first gate clock signal, a gate line corresponding to an (n−1)-th gate line may be generated based on the second gate clock signal, a gate signal corresponding to an n-th gate line may be generated based on the third gate clock signal, where n is a natural number greater than or equal to 3, and the gate signal generated based on each of the first to third gate clock signals may be transited from a low level to a high level during the pre-charging period such that a data signal corresponding to the (n−1)-th gate line and a data signal corresponding to the (n−2)-th gate line may be charged in a pixel corresponding to the n-th gate line during the pre-charging period. In such an embodiment, each rising edge of the gate signals may be overshot, and each falling edge of the gate signals may be undershot.

In an exemplary embodiment, the liquid crystal display apparatus may further include a voltage generating part which generates a first gate-on voltage, a second gate-on voltage higher than the first gate-on voltage, a first gate-off voltage and a second gate-off voltage lower than the first gate-off voltage, where each rising edge of the gate signals may be overshot and each falling edge of the gate signal may be undershot using the first gate-on voltage, the second gate-on voltage, the first gate-off voltage and the second gate-off voltage.

In an exemplary embodiment, each of the first to third gate clock signals may have a rising edge gradually delayed with respect to a vertical synchronization signal.

In an exemplary embodiment, the liquid crystal display panel may have a staggered arrangement in which pixels adjacent to each other in a column direction are connected to data lines different from each other.

In an exemplary embodiment, the timing control part may output a first gate clock signal and a second gate clock signal. In such an embodiment, a period of each of the first and second gate clock signals may include a pre-charging period and a main-charging period. In such an embodiment, a gate line corresponding to an (n−1)-th gate line may be generated based on the first gate clock signal, a gate signal corresponding to an n-th gate line may be generated based on the second gate clock signal, where n is a natural number greater than or equal to 2, and the gate signal generated based on each of the first and second gate clock signals may be transited from a low level to a high level during the pre-charging period such that a data signal corresponding to the (n−1)-th gate line may be charged in a pixel corresponding to the n-th gate line during the pre-charging period.

In an exemplary embodiment, each of the first and second gate clock signals may have a rising edge gradually delayed with respect to a vertical synchronization signal.

In an exemplary embodiment, the timing control part may output a first gate clock signal and a second gate clock signal. In such an embodiment, a period of each of the first and second gate clock signals may include a pre-charging period and a main-charging period. In such an embodiment, a gate line corresponding to an (n−1)-th gate line may be generated based on the first gate clock signal, a gate signal corresponding to an n-th gate line may be generated based on the second gate clock signal, where n is a natural number greater than or equal to 2, and the gate signal generated based on each of the first and second gate clock signals may be transited from a low level to a high level during the pre-charging period such that a data signal corresponding to the (n−1)-th gate line may be charged in a pixel corresponding to the n-th gate line during the pre-charging period. In such an embodiment, each rising edge of the gate signals may be overshot, and each falling edge of the gate signals may be undershot.

In an exemplary embodiment, the liquid crystal display apparatus may further include a voltage generating part which generates a first gate-on voltage, a second gate-on voltage higher than the first gate-on voltage, a first gate-off voltage and a second gate-off voltage lower than the first gate-off voltage, where each rising edge of the gate signals may be overshot and each falling edge of the gate signal may be undershot using the first gate-on voltage, the second gate-on voltage, the first gate-off voltage and the second gate-off voltage.

In an exemplary embodiment, each of the first and second gate clock signals may have a rising edge gradually delayed with respect to a vertical synchronization signal.

According to exemplary embodiments of a method of driving a liquid crystal display panel and a liquid crystal display apparatus for performing the method of the invention, an interval between rising edges of gate signals adjacent to each other is increased as a distance between the liquid crystal cell receiving the gate signal and a data driving part increases, such that a loss of a pixel-charging rate generated by resistive-capacitive (“RC”) delay is effectively compensated, and a luminance of a three-dimensional (“3D”) image is thereby substantially enhanced. In such embodiments, an outputting of a gate signal is gradually shifted as a distance between the liquid crystal cell receiving the gate signal and a lower area of a liquid crystal display panel decreases, such that a charging rate of a pixel is effectively compensated.

### BRIEF DESCRIPTION OF THE DRAWINGS

The above and other features of the invention will become more apparent by describing in detailed exemplary embodiments thereof with reference to the accompanying drawings, in which:

FIG. 1 is an exploded perspective view of an exemplary embodiment of a liquid crystal display apparatus, which displays an image on a screen;

FIG. 2 is a signal timing diagram showing data signals and a light-emitting timing of a liquid crystal display panel described in FIG. 1;

FIG. 3 is a block diagram showing an exemplary embodiment of a liquid crystal display apparatus according to the invention;

FIG. 4 is a block diagram showing an exemplary embodiment of a liquid crystal display panel of FIG. 3;

FIG. 5 is a signal timing diagram showing an exemplary embodiment of driving signals of the liquid crystal display apparatus, show in FIG. 3;

FIG. 6 is waveform diagrams showing a pre-charging and a shift of a gate signal described in FIG. 5;

FIG. 7 is a signal timing diagram showing alternative exemplary embodiment of driving signals of the liquid crystal display apparatus described in FIG. 3;

FIG. 8 is a block diagram showing an exemplary embodiment of a voltage generating part that generates overshooting and undershooting in gate signals of the liquid crystal display apparatus;

FIG. 9A is a waveform diagram showing an exemplary embodiment of an output voltage of a voltage generation part in FIG. 8;

FIG. 9B is a waveform diagram showing an exemplary embodiment of a gate signal outputted from a gate driving part in FIG. 8;

FIG. 10 is a block diagram showing an alternative exemplary embodiment of a voltage generating part that generates overshooting and undershooting in the gate signals of the liquid crystal display apparatus;

FIG. 11A is a waveform diagram showing an exemplary embodiment of an output voltage of the voltage generation part in FIG. 10;

FIG. 11B is a waveform diagram showing an exemplary embodiment of a gate signal outputted from the gate driving part in FIG. 10;

FIG. 12 is a block diagram showing an alternative exemplary embodiment of a liquid crystal display apparatus according to the invention;

FIG. 13 is a block diagram showing an exemplary embodiment of a liquid crystal display panel of FIG. 12;

FIG. 14 is a signal timing diagram showing an exemplary embodiments of driving signals of the liquid crystal display apparatus in FIG. 12;

FIG. 15 is a signal timing diagram showing an alternative exemplary embodiment of the driving signals of the liquid crystal display apparatus in FIG. 12; and

FIG. 16 is a waveform diagram showing an exemplary embodiment of a gate signal having an overshoot and an undershoot in the liquid crystal display apparatus of FIG. 15.

### DETAILED DESCRIPTION

The invention will be described more fully hereinafter with reference to the accompanying drawings, in which exemplary embodiments of the invention are shown.

This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of a method of driving a liquid crystal display panel and a liquid crystal display apparatus for performing the method according to the invention will be described in detail with reference to the accompanying drawings.

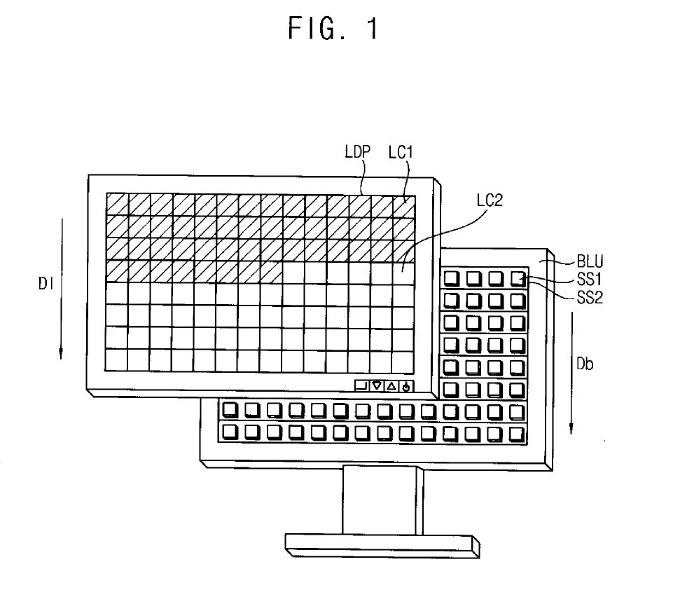

FIG. 1 is an exploded perspective view of an exemplary embodiment of a liquid crystal display apparatus, on which an image is displayed.

Referring to FIG. 1, a liquid crystal display apparatus includes a liquid crystal display panel LDP and a backlight BLU.

The liquid crystal display panel LDP includes a plurality of liquid crystal cells LC1 and LC2. In an exemplary embodiment, as shown in FIG. 1, the liquid crystal cells may be arranged substantially in a matrix form. In an exemplary embodiment, each of the liquid crystal cells LC1 and LC2 may include a thin-film transistor. The thin-film transistor may be an amorphous-silicon transistor or a metal oxide semiconductor transistor.

The backlight unit BLU includes a plurality of light source substrate SS2 and a plurality of light sources SS1 disposed on a corresponding light source substrate of the light source substrate SS2. In one exemplary embodiment, for example, the light sources SS1 may be a light-emitting diode (“LED”). In an alternative exemplary embodiment, the light sources SS1 may be an electro luminescence (“EL”), a cold cathode fluorescent lamp (“CCFL”), a hot cathode fluorescent lamp (“HCFL”) or an external electrode fluorescent lamp (“EEFL”), for example.

In an exemplary embodiment, voltages corresponding to each image pixel are applied to the liquid crystal cells LC1 and LC2 to display an image on the liquid crystal panel LDP, and then lights are provided to the liquid crystal cells LC1 and LC2 by the light sources SS1 of the backlight unit BLU.

An electric field is generated on the liquid crystal cells LC1 and LC2 along a first direction D1, e.g., a scan direction, every pixel line. In an exemplary embodiment, as shown in FIG. 1, the scan direction D1 may be a direction from an upper portion of the liquid crystal panel LDP to a lower portion of the liquid crystal panel LDP. In an alternative exemplary embodiment, the scan direction D1 may be various directions based on a driving of a display apparatus. Liquid crystals in the liquid crystal cells LC1 and LC2 corresponding to each pixel are arranged sequentially in the scan direction D1 based on an image of a current frame to be displayed. In such an embodiment, the liquid crystal cells LC1 and LC2 may include a first liquid crystal cell LC1, in which an arrangement of liquid crystal is completed or being completed corresponding to the image of the current frame, and a second liquid crystal cell LC2, in which an arrangement of liquid crystal is not completed corresponding to the image of the current frame, when the electric field is sequentially generated in the liquid crystal cells LC1 and LC2. In such an embodiment, the second liquid crystal cell LC2, in which an arrangement of liquid crystal is not completed corresponding to the image of the current frame, may be arranged corresponding to an image of a previous frame.

After the electric field is generated in the liquid crystal cells LC1 and LC2, the light sources SS1 of the backlight unit BLU are driven to provide the liquid crystal cells LC1 and LC2 with light. In an exemplary embodiment, the light sources SS1 of the backlight unit BLU may be individually driven, e.g., driven independently of each other, in each area to sequentially provide light to the liquid crystal cell LC1 in which an electric field is generated.

In an alternative exemplary embodiment, the light sources SS1 of the backlight unit BLU may be divided into a plurality of groups, and the plurality of groups of the light sources SS1 may be independently driven to provide the liquid crystal cells LC1 and LC2 with the light. In an exemplary embodiment, where the light sources SS1 of the backlight unit BLU are individually driven in each area, the light sources SS2 may be sequentially driven along a backlight driving direction Db of the backlight unit BLU substantially parallel to the scan direction D1 of the liquid crystal cells LC1 and LC2.

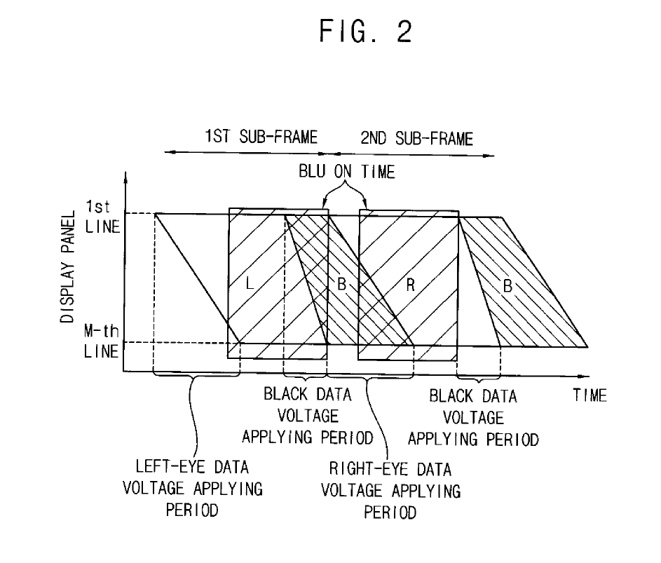

FIG. 2 is a signal timing diagram showing data signals and a light-emitting timing of a liquid crystal display panel LDP of FIG. 1.

Referring to FIG. 2, a time duration, during which a left-eye data voltage L or a right-eye data voltage R is applied to the liquid crystal display panel LDP may be different from a time duration, during which a black voltage B is applied to the liquid crystal display panel LDP. In one exemplary embodiment, for example, the time, during which the left-eye data voltage L or the right-eye data voltage R is applied to the liquid crystal display panel LDP, may be greater than the time duration during which the black voltage B is applied t to the liquid crystal display panel LDP. In an exemplary embodiment, as shown in FIG. 2, a left-eye data voltage L, a black data voltage B, a right-eye data voltage R and a black data voltage B are sequentially applied to the liquid crystal display panel LDP. In an alternative exemplary embodiment, a right-eye data voltage R, a black data voltage B, a left-eye data voltage L and a black data voltage B may be sequentially applied to the liquid crystal display panel LDP. In an exemplary embodiment, as shown in FIG. 2, a left-eye image and a right-eye image may be displayed during an image frame. In such an embodiment, an interval, during which the left-eye data voltage L and the black data voltage B are applied to the liquid crystal display panel LDP in correspondence with the left-eye image, may be a first sub-frame. In such an embodiment, an interval, during which the right-eye data voltage R and the black data voltage B are applied to the liquid crystal display panel LDP in correspondence with the right-eye image, may be a second sub-frame.

In an exemplary embodiment, as shown in FIG. 2, a left-eye data voltage L, a black data voltage B, a right-eye data voltage R and a black data voltage B are provided to the liquid crystal display panel LDP. A maintaining interval of each of the data voltages, in which the level of each of the data voltages is maintained in the liquid crystal display panel LDP, is shown in FIG. 2.

In an exemplary embodiment, when a left-eye or right eye data voltage L or R is applied to a liquid crystal cell of the display panel, a maintaining interval of the left-eye or right eye data voltage L or R is gradually decreased as a distance between the liquid crystal cell that receives the left-eye or right eye data voltage L or R and the data driving part increases.

In an exemplary embodiment, where a data driving part that outputs a data signal is disposed adjacent to an upper area of the liquid crystal display panel LDP and the gate lines are scanned from the upper area of the liquid crystal display panel LDP to a lower area of the liquid crystal display panel LDP, a maintaining interval of the left-eye data voltage L and a maintaining interval of the right-eye data voltage R may be gradually decreased as the left-eye data voltage L or the right-eye data voltage R transmits to the lower area of the liquid crystal display panel LDP from the upper area of the liquid crystal display panel LDP. In such an embodiment, the maintaining interval of the left-eye data voltage L or the right-eye data voltage R at a first horizontal line 1st LINE of the liquid crystal display panel LDP may be the longest, and the maintaining interval of the left-eye data voltage L or the right-eye data voltage R at the last horizontal line M-th LINE of the liquid crystal display panel LDP may be the shortest.

In such an embodiment, where the data driving part is disposed adjacent to the upper area of the liquid crystal display panel LDP and the gate lines are scanned from the upper area of the liquid crystal display panel LDP to the lower area of the liquid crystal display panel LDP, a maintaining interval of the black data voltage B may be gradually increased as the black data voltage B transmits to the lower area of the liquid crystal display panel LDP from the upper area of the liquid crystal display panel LDP. In such an embodiment, a maintaining interval of the black data voltage B at the first horizontal line 1st LINE of the liquid crystal display panel LDP may be the shortest, and a maintaining interval of the black data voltage B at the last horizontal line M-th LINE of the liquid crystal display panel LDP may be the longest.

In an alternative exemplary embodiment, a data driving part may be disposed adjacent to the lower area of the liquid crystal display panel LDP and the gate lines may be scanned from the lower area of the liquid crystal display panel LDP to the upper area of the liquid crystal display panel LDP. In such an embodiment, the maintaining interval of the left-eye data voltage L or the right-eye data voltage R may be gradually decreased as the left-eye data voltage L or the right-eye data voltage R transmits to the upper area of the liquid crystal display panel LDP from the lower area of the liquid crystal display panel LDP. In such an embodiment, the maintaining interval of the left-eye data voltage L or the right-eye data voltage R at the first horizontal line 1st LINE of the liquid crystal display panel LDP may be the shortest, and the maintaining interval of the left-eye data voltage L or the right-eye data voltage R at the last horizontal line M-th LINE of the liquid crystal display panel LDP may be the longest.

In such an embodiment, where the data driving part is disposed adjacent to the lower area of the liquid crystal display panel LDP and the gate lines are scanned from the upper area of the liquid crystal display panel LDP to the lower area of the liquid crystal display panel LDP, the maintaining interval of the black data voltage B may be gradually decreased as the black data voltage B transmits to the lower area of the liquid crystal display panel LDP from the upper area of the liquid crystal display panel LDP. In such an embodiment, the maintaining interval of the black data voltage B at the first horizontal line 1st LINE of the liquid crystal display panel LDP may be the longest, and the maintaining interval of the black data voltage B at the last horizontal line M-th LINE of the liquid crystal display panel LDP may be the shortest.

In an exemplary embodiment, as shown in FIG. 2, a refresh data signal may the black data voltage, but not being limited thereto. In an alternative exemplary embodiment, the refresh data signal may be a white data voltage.

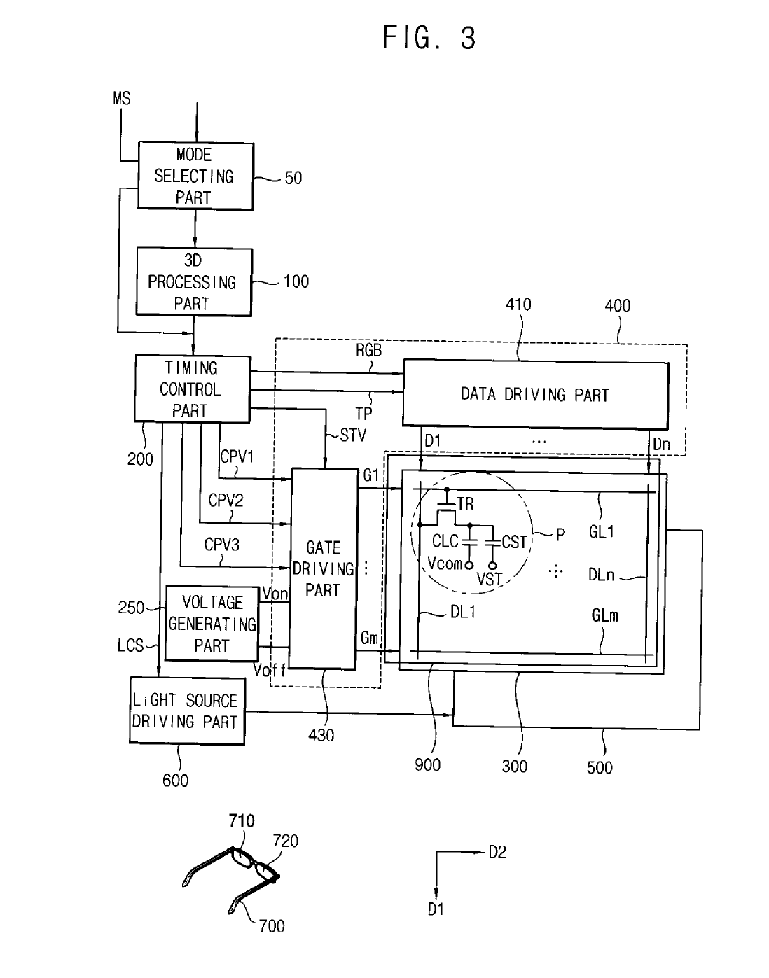

FIG. 3 is a block diagram showing an exemplary embodiment of a liquid crystal display apparatus according to the invention. In FIG. 3, a vertical start signal STV, a load signal TP and three gate clock signals, e.g., a first to third gate clock signal CPV1 to CPV3 are shown. In an exemplary embodiment, as shown in FIG. 3, a charging rate of a pixel is compensated by pre-charging a pixel and by shifting a gate signal. In an exemplary embodiment, the vertical start signal STV is an initial carry signal of a gate integrated circuit (“IC”) shift register and outputted every image frame as a start vertical transistor-transistor-logic (“TTL”) signal. In such an embodiment, the vertical start signal STV indicates an output time of a gate-on pulse (e.g., a high interval of a gate signal). The load signal TP is outputted to every line as a trigger point TTL signal, which is a signal for controlling a data output of a data driving IC. A gate clock signal is a clock pulse vertical TTL, which is a signal for controlling an output of a gate signal during the high interval of the gate signal. In such an embodiment, the gate clock signal controls an output time of the gate-on pulse.

Referring to FIG. 3, an exemplary embodiment of a liquid crystal display apparatus according to the invention includes a mode selecting part 50, a three-dimensional (“3D”) processing part 100, a timing control part 200, a voltage generating part 250, a liquid crystal display panel 300, a panel driving part 400, a light source part 500, a light source driving part 600 and a glasses part 700.

The mode selecting part 50 provides the 3D processing part 100 or the timing control part 200 with a source data of an image frame unit provided from an external device (not shown) in response to a mode selection signal MS provided based on an operation of a user. In one exemplary embodiment, for example, the mode selecting part 50 provides the timing control part 200 with the source data of an image frame unit when a two-dimensional (“2D”) mode is selected, and the mode selecting part 50 provides the 3D processing part 100 with the source data of an image frame unit when a 3D mode is selected.

In an exemplary embodiment, the 3D processing part 100 processes received source data into 3D image data in a 3D image mode on a frame-unit-by-frame-unit basis. In one exemplary embodiment, for example, 3D image data in a frame unit may correspond to data used to display an image using all pixels of the display panel 300 during a predetermined period. In such an embodiment, the 3D processing part 100 divides the source data frame into a left-eye data and a right-eye data. In such an embodiment, the 3D processing part 100 respectively scales the left-eye and right-eye data into left-eye and right-eye data frames corresponding to a resolution of the display panel 300. In one exemplary embodiment, for example, if the 3D processing part receives the left-eye and right-eye frames in a resolution that is incompatible with the resolution of the display panel 300, the 3D processing part may convert the left-eye and right-eye frames into converted left-eye and right-eye frames that are compatible with the resolution of the liquid crystal display panel 300. The 3D processing part 100 sequentially outputs the left-eye data frame and the right-eye data frame.

The timing control part 200 receives a 3D image data from the 3D processing part 100 or a source data provided from an external device (not shown). The timing control part 200 outputs an image signal RGB for displaying an image and a panel control signal for driving the panel driving part 400 to the panel driving part 400, and outputs a light source control signal LCS for driving the light source driving part 600 to the light source driving part 600. In an exemplary embodiment, as shown in FIG. 3, the panel control signal includes the load signal TP, the vertical start signal STV, the first gate clock signal CPV1, the second gate clock signal CPV2 and the third gate clock signal CPV3, described above.

In an exemplary embodiment, the timing control part 200 provides the panel driving part 400 with the first gate clock signal CPV1, the second gate clock signal CPV2 and the third gate clock signal CPV3, which increase an interval between rising edges of gate signals adjacent to each other as the distance of the liquid crystal cell receiving the gate signal and a side, from which the image signal RGB is applied, increases. In an exemplary embodiment, the side from which the image signal RGB is applied is an upper portion of the liquid crystal display panel 300, and the timing control part 200 provides the panel driving part 400 with the first to third gate clock signals CPV1, CPV2 and CPV3, which increase the interval between rising edges of gate signals adjacent to each other as the distance between a gate line that receives the gate signal and a lower gate line increases on the liquid crystal display panel 300. Here, the lower gate line means a gate line disposed at a lower portion of the liquid crystal display panel 300. In an alternative exemplary embodiment, the side from which the image signal RGB is applied may be a lower portion of the liquid crystal display panel 300, and the timing control part 200 provides the panel driving part 400 with the first to third gate clock signals CPV1, CPV2 and CPV3, which increase the interval between rising edges of gate signals adjacent to each other as the distance between the gate line that receives the gate signal and an upper gate line increases on the liquid crystal display panel 300. Here, the upper gate line means a gate line disposed at an upper portion of the liquid crystal display panel 300.

The voltage generating part 250 outputs a gate-on voltage Von and a gate-off voltage Voff, which define a voltage level of a gate signal, to the gate driving part 430.

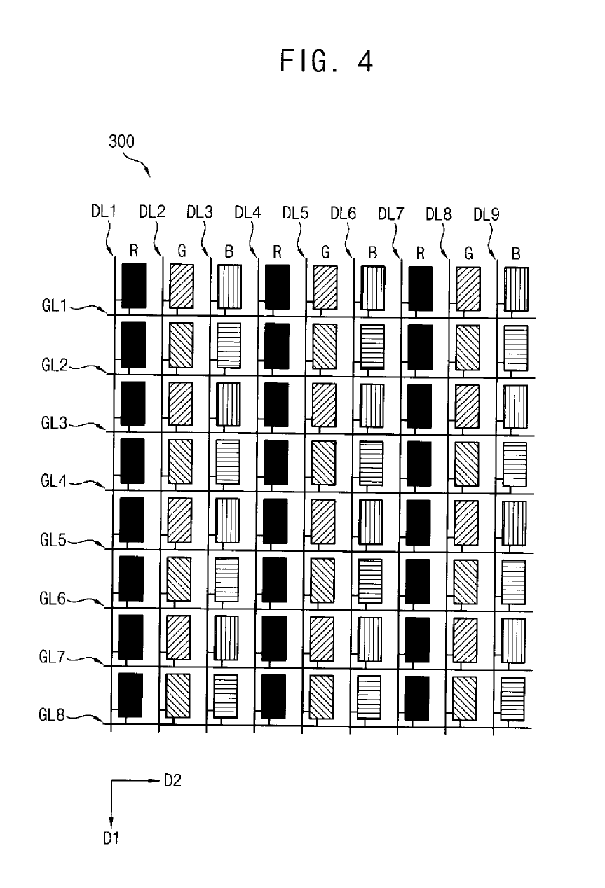

The liquid crystal display panel 300 includes first to n-th data lines DL1 to DLn, first to m-th gate lines GL1 to GLm and a plurality of pixels P. Here, ‘n’ and ‘m’ are natural numbers. In an exemplary embodiment, the first to n-th data lines DL1 to DLn may extend substantially in a first direction D1, and the first to m-th gate lines GL1 to GLm may extend substantially in a second direction. Each of the pixels P includes a switching element TR connected to a corresponding data line and a corresponding gate line, a liquid crystal capacitor CLC having a first terminal connected to the switching element TR and a storage capacitor CST having a first terminal connected to the switching element TR. A common electrode voltage Vcom is applied to a second terminal of the liquid crystal capacitor CLC, and a storage voltage VST is applied to a second terminal of the storage capacitor CST. In an exemplary embodiment, the liquid crystal display panel 300 may have a non-staggered arrangement, which will be described in detailed with reference to FIG. 4.

The panel driving part 400 includes a data driving part 410 and a gate driving part 430. The panel driving part 400 sequentially outputs a left-eye image, a refresh image, a right-eye image and the refresh image to the liquid crystal display panel 300 using the received data. In an exemplary embodiment, the refresh image may be a black image for increasing contrast ratio of an image. In an alternative exemplary embodiment, the refresh image may be a white image for increasing a brightness of an image in a low power. Hereinafter, for convenience of description, an exemplary embodiment where the refresh image is a black image will be described.

In an exemplary embodiment, the data driving part 410 outputs a data voltage of the left-eye data frame to the liquid crystal display panel 300 during a first period, blocks the data voltage from being provided to the liquid crystal display panel 300 during a second period, and outputs a black data voltage to the liquid crystal display panel 300 during the second period based on a control of the timing control part 200, as described in FIG. 2. In such an embodiment, the data driving part 410 outputs a data voltage of the right-eye data frame to the liquid crystal display panel 300 during a third period, blocks the data voltage from being provided to the liquid crystal display panel 300 during a fourth period, and outputs a black data voltage to the liquid crystal display panel 300 during the fourth period based on the control of the timing control part 200.

The gate driving part 430 provides gate lines GL1 to GLm of the liquid crystal display panel 300 with gate signals based on a gate-on voltage Von and a gate-off voltage Voff that are provided from the voltage generating part 250. In an exemplary embodiment, as shown in FIG. 3, the gate driving part 430 outputs a plurality of gate signals, e.g., first to m-th gate signals G1 to Gm, to the liquid crystal display panel 300 based on the first gate clock signal CPV1, the second gate clock signal CPV2 and the third gate clock signal CPV3 that are provided from the timing control part 200, such that an interval between rising edges of gate signals G1 to Gm is increased as a distance between the gate line that receives the gate signal and the data driving part 410 increases.

In such an embodiment, the timing control part 200 provides the gate driving part 430 with the gate clock signals CPV1, CPV2 and CPV3 increasing an interval between rising edges of gate signals G1 to Gm as the distance between the gate line that receives the gate signal and the data driving part 410 increases, and the gate driving part 430 provided the liquid crystal display panel 300 with the gate signals G1 to Gm having a gradually increasing the interval based on the gate clock signals CPV1, CPV2 and CPV3 as the distance between gate lines that receive the gate signals G1 to Gm and the data driving part 410 increases. In one exemplary embodiment, for example, the gate driving part 430 may be configured in a chip type. In an alternative exemplary embodiment, the gate driving part 430 may be integrated on the liquid crystal display panel 300. In such an embodiment, where the gate driving part 430 is integrated to the liquid crystal display panel 300, the gate driving part 430 may be integrated on liquid crystal display panel 300 during a process in which switching elements TR are provided on the liquid crystal display panel 300.

The light source part 500 provides light to the liquid crystal display panel 300 in response to the light source control signal LCS provided from the timing control part 200. The light source part 500 may be configured as a direct-illumination type or an edge-illumination type. The light source part 500 of the edge-illumination type includes a light guide plate (“LGP”) disposed under the liquid crystal display panel 300 and a light source disposed at an edge portion of the LGP. The light source part 500 of the direct-illumination type includes a light source directly disposed under the liquid crystal display panel 300, and does not include the LGP. In one exemplary embodiment, for example, the light source includes a light emitting diode.

The light source driving part 600 drives the light source part 500 based on the control of the timing control part 200. In an exemplary embodiment, the light source driving part 600 drives the light source part 500 using a global blinking method. In one exemplary embodiment, for example, the light source part 500 provides light to the liquid crystal display panel 300 during a period, in which the left-eye frame image or the right-eye frame image corresponding to the left-eye data frame or the right-eye data frame is displayed on the liquid crystal display panel 300, and blocks the light from the liquid crystal display panel 300 during a period, in which the black frame image corresponding to the black data voltage is displayed on the liquid crystal display panel 300.

The glasses part 700 includes a left-eye part 710 and a right-eye part 720. In an exemplary embodiment, the glasses part 700 may use an active shutter glasses mode or a passive polarization glasses mode. The left-eye part 710 transmits the left-eye frame image and blocks the right-eye frame image. The right-eye part 720 transmits the right-eye frame image and blocks the left-eye frame image.

In an exemplary embodiment, where the glasses part 700 uses the passive polarization glasses mode, the liquid crystal display apparatus may further include a polarization panel 900 disposed on the liquid crystal display panel 300. The polarization panel 900 changes the left-eye frame image and the right-eye frame image displayed on the liquid crystal display panel 300 into polarized light different from each other. Thus, the left-eye part 710 and the right-eye part 720 of the glasses part 700 may selectively transmit the polarized left-eye frame image and the right-eye frame image.

In the exemplary embodiment shown in FIG. 3, the liquid crystal display panel 300 may be a panel configured to be driven with low frequency. In an exemplary embodiment, where the liquid crystal display panel 300 is driven with high frequency, a gradual blank frame insertion is adapted when a 3D image is displayed such that a pixel-charging rate increases. In such an embodiment, a pre-charging interval is maintained to be equal to or greater than one horizontal period 1H by pre-charging a data signal corresponding to an (n−2)-th gate line and a data signal corresponding to an (n−1)-th gate line in a pixel corresponding to an n-th gate line with respect to a gate scan direction, such that a pixel-charging rate corresponding to a pixel corresponding to a current gate line (or the n-th gate line) is increased.

In an exemplary embodiment, an interval between rising edges of gate signals adjacent to each other is increased, as the distance between that gate line that receives the gate signal and the data driving part 410 increases that outputs a data signal, such that a loss of a pixel-charging rate generated by RC delay may be compensated. In one exemplary embodiment, for example, the liquid crystal display panel 300 may be configured to be driven in a frequency of about 120 hertz (Hz). In such an embodiment, the liquid crystal display panel 300 may be driven at a frequency of about 120 Hz when the liquid crystal display panel 300 operates in a 2D mode, and the liquid crystal display panel 300 may be driven at a frequency of about 240 Hz when the liquid crystal display panel 300 operates in a 3D mode.

FIG. 4 is a block diagram shown an exemplary embodiment of a liquid crystal display panel 300 of FIG. 3. Hereinafter, an exemplary embodiment of a liquid crystal display panel having a non-staggered arrangement will be described in detail. In the liquid crystal display panel of the non-staggered arrangement, pixels adjacent to each other in a column direction are connected to the same data line. For convenience of description, an exemplary embodiment of a liquid crystal display panel having a pixel structure of 9×8 will be described.

Referring to FIG. 4, an exemplary embodiment of the liquid crystal display panel LDP 300 includes first to ninth data lines DL1 to DL9, first to eighth gate lines GL1 to GL8 and a plurality of pixels, but not being limited thereto or thereby. In FIG. 4, an exemplary embodiment including eight gate lines, nine data lines and seventy-two pixels disposed on the liquid crystal display panel 300 are shown for convenience of description.

In an exemplary embodiment, as shown in FIG. 4, the first to ninth data lines DL1 to DL9 extend substantially in a first direction D1, and the data lines adjacent to each other are substantially parallel to each other and arranged along a second direction D2. The first direction D1 and the second direction D2 cross each other, and may be substantially perpendicular to each other. In FIG. 4, the first direction D1 may correspond with a column direction, and the second direction D2 may correspond to a row direction.

The first to eighth gate lines GL1 to GL8 extend substantially in the second direction D2, and the gate lines adjacent to each other are substantially parallel to each other and arranged along the first direction D1.

Each of the pixels may include a switching element (not shown) connected to a corresponding gate line and a corresponding data line thereof, a liquid crystal capacitor (not shown) connected to the switching element and a storage capacitor (not shown) connected to the switching element.

In an exemplary embodiment, a pixel corresponding to an odd-numbered row of an odd-numbered column is connected to an odd-numbered data line and an odd-numbered gate line, and a pixel corresponding to an even-numbered row of an odd-numbered column is connected to an odd-numbered data line and an even-numbered gate line. A pixel corresponding to an odd-numbered row of an even-numbered column is connected to an even-numbered data line and an odd-numbered gate line, and a pixel corresponding to an even-numbered column of an even-numbered row is connected to an even-numbered data line and an even-numbered gate line.

In one exemplary embodiment, for example, a pixel corresponding to a first row of a first column is connected to the first data line DL1 and the first gate line GL1, and a pixel corresponding to a second row of the first column is connected to the first data line DL1 and the second gate line GL2. A pixel corresponding to a third row of the first column is connected to the first data line DL1 and the third gate line GL3, and a pixel corresponding to a fourth row of the first column is connected to the first data line DL1 and the fourth gate line GL4.

A pixel corresponding to the first row of a second column is connected to the second data line DL2 and the first gate line GL1, and a pixel corresponding to the second row of the second column is connected to the second data line DL2 and the second gate line GL2. A pixel corresponding to the third row of the second column is connected to the second data line DL2 and the third gate line GL3, and a pixel corresponding to the fourth row of the second column is connected to the second data line DL2 and the fourth gate line GL4.

In a similar manner, a pixel corresponding to a sixth row of a fifth column is connected to the fifth data line DL5 and the sixth gate line GL6, and a pixel corresponding to a seventh row of the fifth column is connected to the fifth data line DL5 and the seventh gate line GL7.

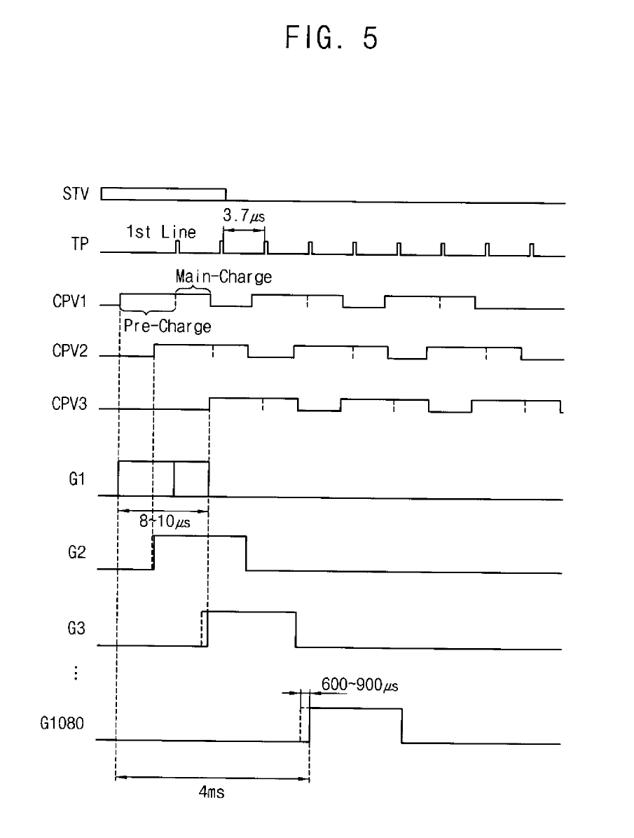

FIG. 5 is a signal timing diagram showing an exemplary embodiment of driving signals of the liquid crystal display apparatus, shown in FIG. 3.

Referring to FIGS. 3 to 5, the vertical start signal STV that indicates a start of an image frame is applied to the gate driving part 430, and then the first clock signal CPV1, the second gate clock signal CPV2 and the third gate clock signal CPV3 are sequentially applied to the gate driving part 430. In an exemplary embodiment, as shown in FIG. 5, the first gate clock signal CPV1 and the second gate clock signal CPV2 overlap each other in a predetermined time, and the second gate clock signal CPV2 and the third gate clock signal CPV3 overlap each other in a predetermined time. In such an embodiment, the first gate clock signal CPV1 does not overlap the third gate clock signal CPV3.

A period of each of the first to third gate clock signals CPV1, CPV2 and CPV3 includes a pre-charging period and a main-charging period. During the pre-charging period, a gate signal is transited from a low level to a high level to charge a data signal corresponding to an (n−1)-th gate line and a data signal corresponding to an (n−2)-th gate line to an n-th pixel corresponding to an n-th gate line. The main-charging period is determined based on the load signal TP. Here, ‘n’ is a natural number greater than or equal to 3. The load signal TP is a signal which loads a data signal to the data line in one horizontal period 1H.

The first gate clock signal CPV1 is outputted to generate an (n−2)-th gate signal, the second gate clock signal CPV2 is outputted to generate an (n−1)-th gate signal, and the third gate clock signal CPV3 is outputted to generate an n-th gate signal. Here, ‘n’ is a natural number greater than or equal to 3.

Rising edges of the first to third gate clock signals CPV1, CPV2 and CPV3 are shifted with respect to the vertical synchronization signal STV. In an exemplary embodiment, as shown in FIG. 5, the rising edges of the first to third gate clock signals CPV1, CPV2 and CPV3 are gradually delayed with respect to a vertical synchronization signal STV. In such an embodiment, a first gate signal G1 has a normal rising edge, a second gate signal G2 has a rising edge delayed by a first interval from the rising edge of the first gate signal G1, and a third gate signal G3 has a rising edge delayed by the first interval from the rising edge of the second gate signal G2. In an exemplary embodiment, when the number of gate lines is 1,080, (1080)-th gate signal G1080 applied to the last gate line may have a rising edge delayed by an interval in a range of about 600 microseconds (μs) to about 900 microseconds (μs) with respect to a rising edge of the first gate signal G1.

In an exemplary embodiment, as described above, the rising edge of the second gate signal G2 is delayed by the first interval from the rising edge of the first gate signal G2, and the rising edge of the third gate signal G3 is delayed by the first interval from the rising edge of the second gate signal G2. In an alternative exemplary embodiment, the rising edge of the second gate signal G2 may be delayed by a first interval from the rising edge of the first gate signal G1, and the rising edge of the third gate signal G3 may be delayed by a second interval from the rising edge of the second gate signal G2. In such an embodiment, the second interval may be greater than the first interval. In an alternative exemplary embodiment, the second interval may be less than the first interval. As described above, in an exemplary embodiment, a data signal corresponding to an (n−1)-th gate signal Gn−1 and a data signal corresponding to an (n−2)-th gate signal Gn−2 are pre-charged in an n-th pixel, thereby compensating a charging rate of the n-th pixel. In such an embodiment, a data signal corresponding a next previous gate signal and a data signal corresponding to a previous gate signal are pre-charged in a current pixel corresponding to a current gate signal, such that a charging rate of the current pixel is substantially increased.

In an exemplary embodiment, as shown in FIG. 3 or FIG. 5, a pre-charging time is provided using three gate clock signals CPV1, CPV2 and CPV3 to increase a pixel-charging rate corresponding to a current pixel. In an alternative exemplary embodiment, a pixel-charging rate may be increased using four or more gate clock signals. In one exemplary embodiment, for example, a data signal corresponding to an (n−1)-th gate signal, a data signal corresponding to an (n−2)-th gate signal and a data signal corresponding to an (n−3)-th gate signal may be pre-charged in the n-th pixel to increase a charging rate of an n-th pixel.

In an exemplary embodiment, an output of a gate signal is gradually shifted as a distance between the gate line that receives the gate signal and a lower area of a liquid crystal display panel decreases due to RC delay, thereby effectively compensating a charging rate of the n-th pixel.

When a gate signal is applied to a gate line of a liquid crystal display panel, the gate signal is delayed due to a resistance of the gate line such that a signal distortion occurs. When a data signal is applied to a data line of a liquid crystal display panel, the data signal is delayed due to a resistance of the data line such that a signal distortion occurs.

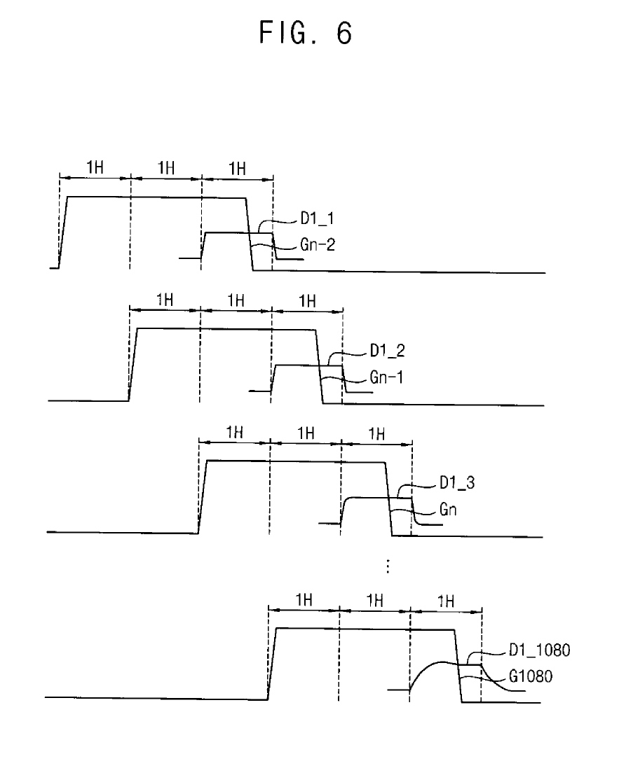

FIG. 6 is waveform diagrams showing a pre-charging and a shift of a gate signal described in FIG. 5. For convenience of description, gate signals of an exemplary embodiment, where a data signal is applied to an upper portion of a liquid crystal display panel and a gate signal is applied to a left portion of the liquid crystal display panel, are shown in FIG. 6, but not being limited thereto.

Referring to FIG. 6, a pulse width of an (n−2)-th gate signal Gn−2 for activating a first switching element (not shown) electrically connected to an (n−2)-th gate line is extended, such that a data signal D1_n−4 corresponding to an (n−4)-th gate line is pre-charged in a first pixel electrically connected to the first switching element and a data signal D1_n−2 corresponding to the (n−2)-th gate line is mainly-charged in the first pixel.

In an exemplary embodiment, the first switching element is a switching element disposed substantially close to the gate driving part that outputs the gate signal. Thus, the (n−2)-th gate signal Gn−2 applied to the first switching element is not distorted, such that the (n−2)-th gate signal Gn−2 applied to the first switching element has a normal rising edge and a normal falling edge. However, the (n−2)-th gate signal Gn−2 applied to a switching element may be distorted due to RC delay when the switching element is spaced apart from the gate driving part, such that the (n−2)-th gate signal Gn−2 applied to the switching element may have a delayed rising edge and a delayed falling edge.

In an exemplary embodiment, the first switching element is a switching element disposed substantially close to the data driving part that outputs the data signal. Thus, data signals D1_n−2 and D1_n−4 applied to the first switching element are not distorted, such that the data signals D1_n−2 and D1_n−4 have a normal rising edge and a normal falling edge. However, the data signals D1_n−2 and D1_n−4 applied to a switching element are distorted due to RC delay when the switching element is spaced apart from the data driving part, such the data signals D1_n−2 and D1_n−4 applied to the switching element may have a delayed rising edge and a delayed falling edge.

A pulse width of an (n−1)-th gate signal Gn−1 for activating a second switching element (not shown) electrically connected to an (n−1)-th gate line is extended, such that a data signal D1_n−3 corresponding to an (n−3)-th gate line is pre-charged in a second pixel electrically connected to the second switching element and a data signal D1_n−1 corresponding to an (n−1)-th gate line is mainly-charged in the second pixel.

A pulse width of an n-th gate signal Gn for activating a third switching element (not shown) electrically connected to an n-th gate line is extended, such that a data signal D1_n−2 corresponding to an (n−2)-th gate line is pre-charged in a third pixel electrically connected to the third switching element and a data signal D1_n corresponding to an n-th gate line is mainly-charged in the third pixel.

In such a manner, a pulse width of the last gate signal G1080 for activating the last switching element (not shown) electrically connected to the last gate line is extended, such that a data signal D1_{—}1078 corresponding to a previous gate line is pre-charged in the last pixel electrically connected to the last switching element and a data signal D1_{—}1080 corresponding to the last gate line is mainly-charged in the last pixel.

As described above, in an exemplary embodiment, a pulse with of a gate signal is extended to maintain a charging time of an n-th pixel by no less than one horizontal period 1H, such that an (n−2)-th data signal may be pre-charged in the n-th pixel. Accordingly, when a rising edge or a falling edge of a data signal is delayed due to RC delay, a charging amount of a pixel is effectively compensated, and a charging amount of a pixel is effectively compensated.

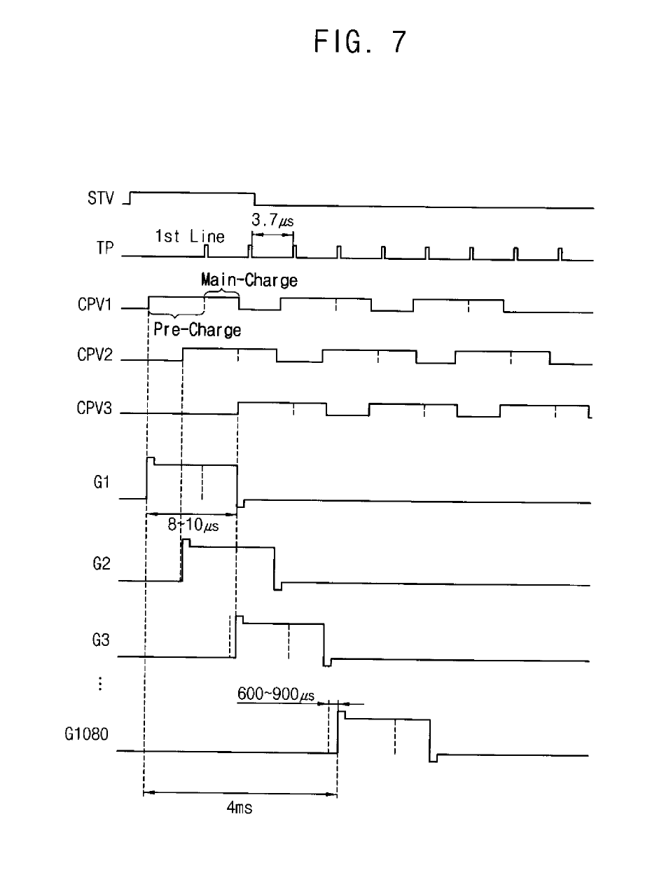

FIG. 7 is a signal timing diagram showing an alternative exemplary embodiment of driving signals of the liquid crystal display apparatus shown in FIG. 3.

Referring to FIGS. 3 and 7, the vertical start signal STV that indicates a start of an image frame is applied to the gate driving part 430, and then the first clock signal CPV1, the second gate clock signal CPV2 and the third gate clock signal CPV3 are sequentially applied to the gate driving part 430.

The period of each of the first to third gate clock signals CPV1, CPV2 and CPV3 includes a pre-charging period and a main-charging period. During the pre-charging period, a gate signal is transited from a low level to a high level to charge a data signal, which is corresponding to an (n−1)-th gate line and a data signal corresponding to an (n−2)-th gate line, to an n-th pixel corresponding to an n-th gate line. The main-charging period is determined based on a load signal TP. The load signal TP is a signal which loads a data signal to the data line in one horizontal period 1H.

The first gate clock signal CPV1 is outputted to generate an (n−2)-th gate signal, the second gate clock signal CPV2 is outputted to generate an (n−1)-th gate signal, and the third gate clock signal CPV3 is outputted to generate an n-th gate signal. Here, ‘n’ is a natural number greater than or equal to 3.

Each of the first to third gate clock signals CPV1, CPV2 and CPV3 has a rising edge gradually delayed with respect to a vertical synchronization signal STV. In such an embodiment, a first gate signal G1 has a normal rising edge, a second gate signal G2 has a rising edge delayed by a first interval from the rising edge of the first gate signal G1, and a third gate signal G3 has a rising edge delayed by the first interval from the rising edge of the second gate signal G2. Therefore, when the number of gate lines is 1,080, (1080)-th gate signal G1080 applied to the last gate line may have a rising edge delayed by about 600 μs to about 900 μs from the rising edge of the first gate signal G1.

In an exemplary embodiment, each rising edge of gate signals are overshot, and each falling edge of gate signals are undershot. Thus, a switching element, which is turned on in response to the overshot gate signal, is turned on substantially faster, such that a data signal is charged in a corresponding pixel of the switching element substantially faster. In such an embodiment, a switching element, which is turned off in response to the undershot gate signal, is turned-off substantially faster, such that a data signal is blocked from being charged in the corresponding pixel. In an alternative exemplary embodiment, each of the gate signals may be overshot in only rising edges of the gate signals. In another alternative exemplary embodiment, each of the gate signals may be undershot in only falling edges of the gate signals. When the gate signals are overshot (or undershot), charging operation and/or discharging operation of pixels may be accelerated. The overshooting or undershooting of the gate signals may be generated by the voltage generating part 250 or the gate driving part 430.

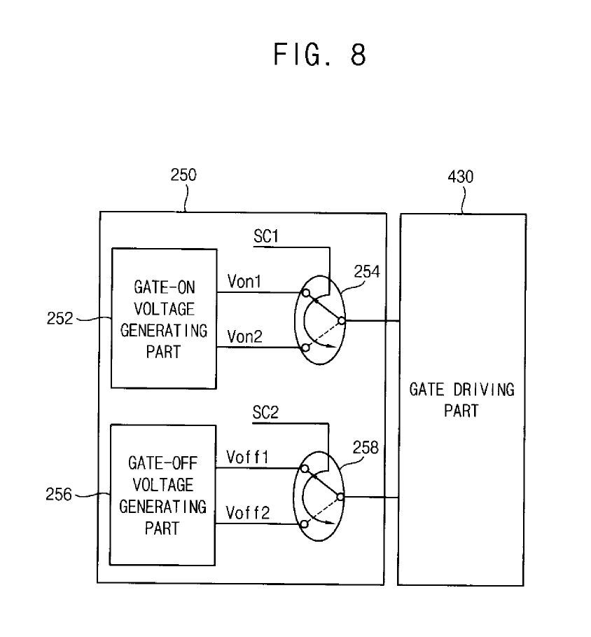

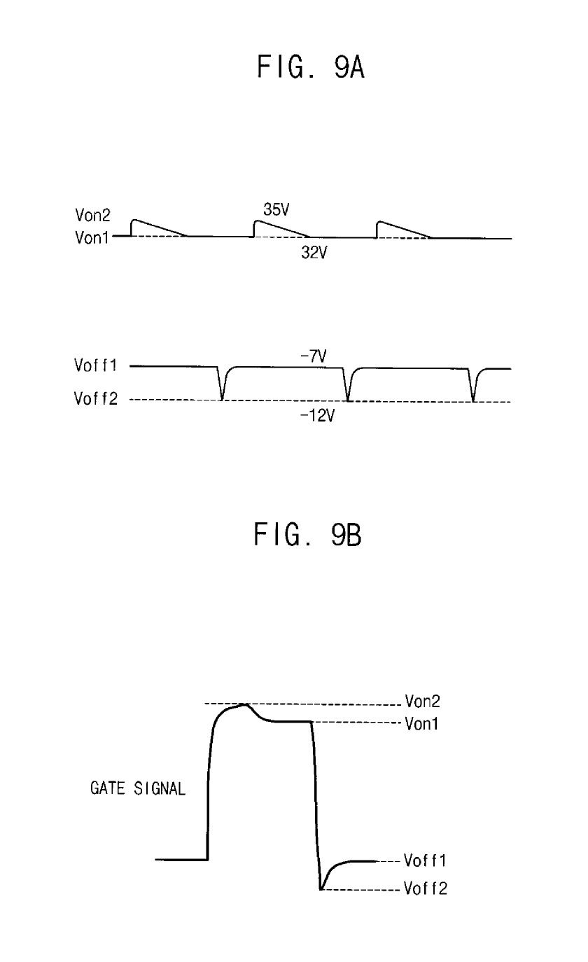

FIG. 8 is a block diagram showing an exemplary embodiment of a voltage generating part that generates overshooting and undershooting in the gate signals of the liquid crystal display apparatus. FIG. 9A is a waveform diagram showing an exemplary embodiment of an output voltage of a voltage generation part 250 in FIG. 8. FIG. 9B is a waveform diagram showing an exemplary embodiment of a gate signal outputted from a gate driving part 430 in FIG. 8.

Referring to FIG. 8 to FIG. 9B, an exemplary embodiment of a voltage generating part 250 includes a gate-on voltage generating part 252, a first switch 254, a gate-off voltage generating part 256 and a second switch 258.

The gate-on voltage generating part 252 outputs a first gate-on voltage Von1 and a second gate-on voltage Von2 to the first switch 254. In an exemplary embodiment, as shown in FIG. 9A, the first gate-on voltage Von1 may be about 32 volts (V), and the second gate-on voltage Von2 may be about 35 V.

The first switch 254 provides the gate driving part 430 with one of the first gate-on voltage Von1 and the second gate-on voltage Von2 in response to a first switch control signal SC1 provided from the timing control part 200 (shown in FIG. 3).

The gate-off voltage generating part 256 outputs a first gate-off voltage Voff1 and a second gate-off voltage Voff2 to the second switch 258. In an exemplary embodiment, as shown in FIG. 9A, the first gate-off voltage Voff1 may be about −7 V, and the second gate-off voltage Voff2 may be about −12 V.

The second switch 258 provides the gate driving part 430 with one of the first gate-off voltage Voff1 and the second gate-off voltage Voff2 in response to a second switch control signal SC2 provided from the timing control part 200 (shown in FIG. 3).

The gate driving part 430 outputs a gate signal configured by, e.g., generated by combining, the first gate-off voltage Voff1 and the first gate-on voltage Von1. In an exemplary embodiment, the second gate-on voltage Von2 is outputted in correspondence with a rising edge of the gate signal, and the second gate-off voltage Voff2 is outputted in correspondence with a falling edge of the gate signal, such that the gate signal is overshot at the rising edge thereof, and is undershot at the falling edge thereof, as shown in FIG. 9B.

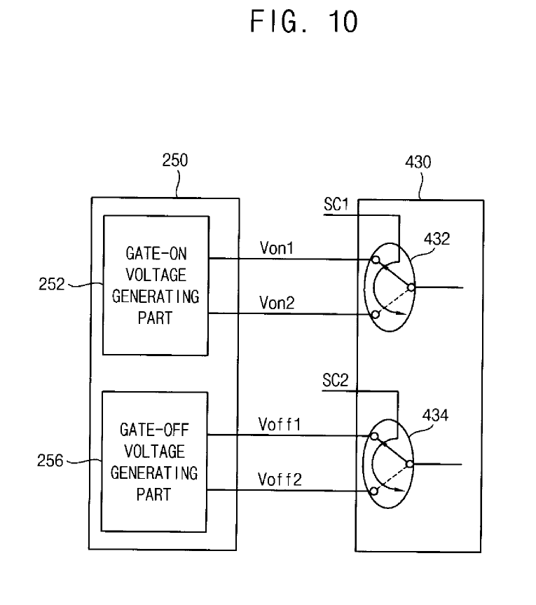

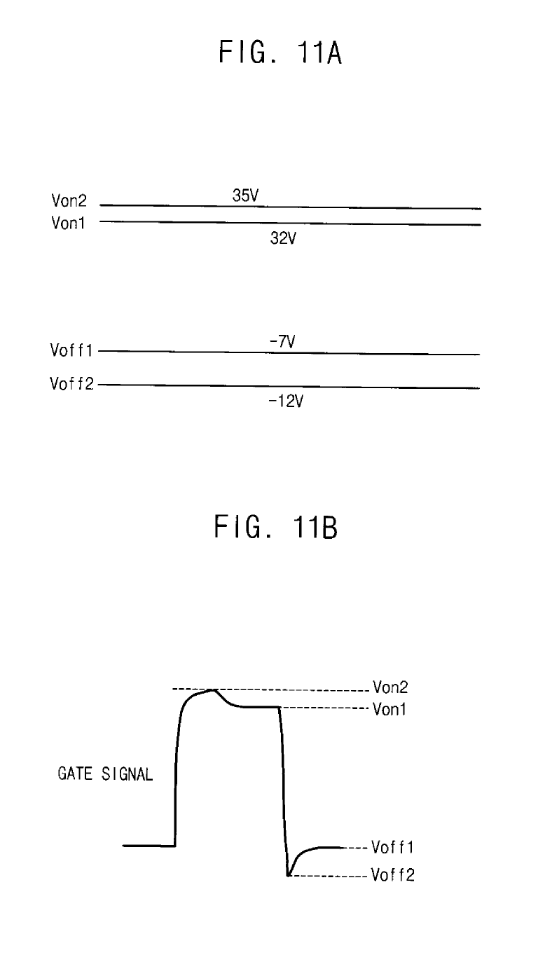

FIG. 10 is a block diagram showing an alternative exemplary embodiment of a voltage generating part that generates overshooting and undershooting in the gate signals of the liquid crystal display apparatus. FIG. 11A is a waveform diagram showing an exemplary embodiment of an output voltage of the voltage generation part 250 in FIG. 10. FIG. 11B is a waveform diagram showing an exemplary embodiment of a gate signal outputted from the gate driving part 430 in FIG. 10.

Referring to FIG. 10 to FIG. 11B, in an exemplary embodiment, a voltage generating part 250 includes a gate-on voltage generating part 252 and a gate-off voltage generating part 256, and a gate driving part 430 includes a first switch 432 and a second switch 434.

The gate-on voltage generating part 252 outputs a first gate-on voltage Von1 and a second gate-on voltage Von2 to the first switch 432. In an exemplary embodiment, as shown in FIG. 11A, the first gate-on voltage Von1 may be about 32 V, and the second gate-on voltage Von2 may be about 35 V.

The gate-off voltage generating part 256 outputs a first gate-off voltage Voff1 and a second gate-off voltage Voff2 to the second switch 434. In an exemplary embodiment, as shown in FIG. 11A, the first gate-off voltage Voff1 may be about −7 V, and the second gate-off voltage Voff2 may be about −12 V.

The first switch 432 generate one of the first gate-on voltage Von1 and the second gate-on voltage Von2 in response to a first switch control signal SC1 provided from the timing control part 200 (shown in FIG. 3).

The second switch 434 generates one of the first gate-off voltage Voff1 and the second gate-off voltage Voff2 in response to a second switch control signal SC2 provided from the timing control part 200 (shown in FIG. 3).

The gate driving part 430 outputs a gate signal configured by, e.g., generated by combining, the first gate-off voltage Voff1 and the first gate-on voltage Von1. In such an embodiment, the second gate-on voltage Von2 is outputted in correspondence with a rising edge of the gate signal, and the second gate-off voltage Voff2 is outputted in correspondence with a falling edge of the gate signal. Thus, as described in FIG. 11B, the gate signal is overshot at the rising edge thereof, and is undershot at the falling edge thereof.

As described above, in an exemplary embodiment, a data signal corresponding to an (n−1)-th gate signal Gn−1 and a data signal corresponding to an (n−2)-th gate signal Gn−2 are pre-charged in an n-th pixel, thereby compensating a charging rate of the n-th pixel. In such an embodiment, a data signal corresponding a next previous gate signal and a data signal corresponding to a previous gate signal are pre-charged in a current pixel corresponding to a current gate signal, such that a charging rate of the current pixel may be increased.

In an exemplary embodiment, an outputting of a gate signal is gradually shifted as the distance between the gate line that receives the gate signal and a lower area of a liquid crystal display panel decreases, thereby compensating a charging rate of the n-th pixel.

In a liquid crystal display panel described in FIG. 4, during an interval during which a gate signal is on, e.g., during a gate-on pulse interval, a difference of a charging amount may be generated in every pixel due to a data signal difference. The difference of a charging amount may cause a horizontal line defect. In one exemplary embodiment, for example, a pixel corresponding to green and a pixel corresponding to blue are activated to display cyan. In such an embodiment, a charging amount of green and a charging amount of blue are different from each other in an odd-numbered line and an even-numbered line, respectively. The difference between the charging amount of green and the charging amount of blue may be summarized as shown in the following Table 1.

TABLE 1

| | Green | Blue | Color |
|---|---|---|---|
| Even-numbered line | Worst charging | Best charging | Bluish |
| Odd-numbered line | Best charging | Worst charging | Greenish |

As shown in Table 1, a bluish color may be displayed in an even-numbered line, and a greenish color may be displayed in an odd-numbered line. As such, when a charging amount of green and a charging amount of blue are different from each other, bluish or greenish color may be displayed such that a horizontal line defect may occur.

In an exemplary embodiment of a liquid crystal display apparatus according to the invention, when a pixel corresponding to an n-th gate line is charged, a data charged in a pixel corresponding to an (n−2)-th gate line is pre-charged in the pixel corresponding to the n-th gate line, such that a horizontal line defect is effectively prevented.

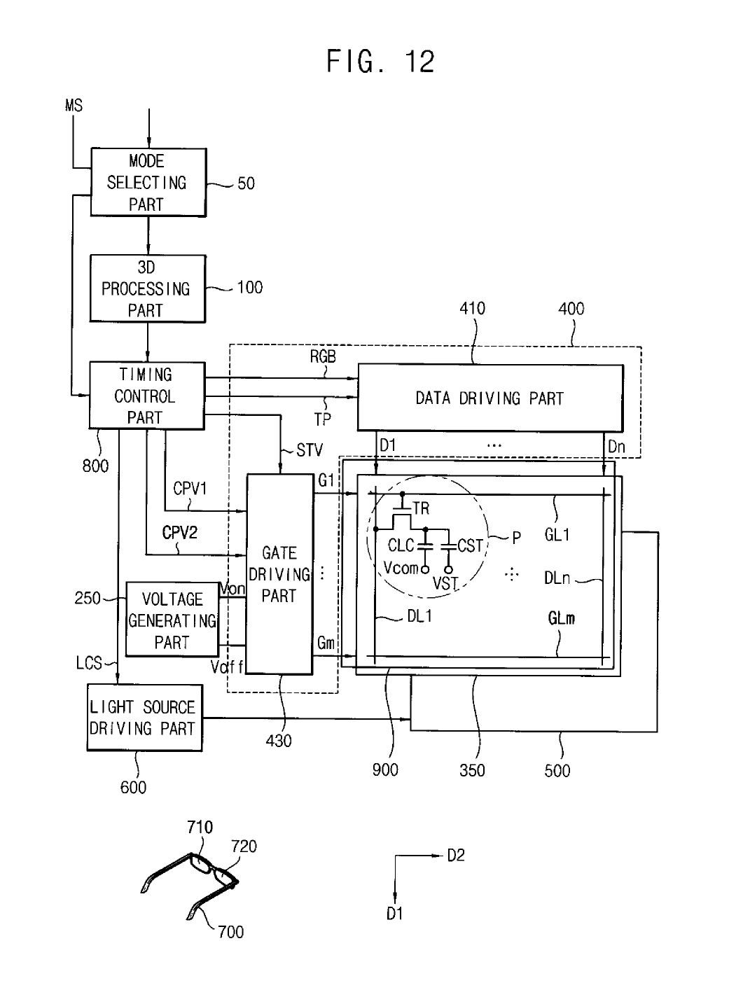

FIG. 12 is a block diagram explaining a liquid crystal display apparatus according to another exemplary embodiment of the invention. In FIG. 12, two vertical start signals STV, a load signal TP and two gate clock signals, e.g., a first gate clock signal CPV1 and a second gate clock signal CPV2, are shown. In an exemplary embodiment, as shown in FIG. 12, a pixel-charging rate is compensated by pre-charging a pixel and by shifting a gate signal.

Referring to FIG. 12, an exemplary embodiment of a liquid crystal display apparatus according to the invention includes a mode selecting part 50, a 3D processing part 100, a timing control part 800, a voltage generating part 250, a liquid crystal display panel 350, a panel driving part 400, a light source part 500, a light source driving part 600 and a glasses part 700. The mode selecting part 50, the 3D processing part 100, the voltage generating part 250, the panel driving part 400, the light source part 500, the light source driving part 600 and the glasses part 700 in the exemplary embodiment of FIG. 9 are substantially the same as the mode selecting part 50, the 3D processing part 100, the voltage generating part 250, the panel driving part 400, the light source part 500, the light source driving part 600 and the glasses part 700 in the exemplary embodiment of FIG. 3, and thus any repetitive detailed description thereof will hereinafter be omitted.

The timing control part 800 outputs an image signal RGB for displaying an image and a panel control signal for driving the panel driving part 400 to the panel driving part 400, and outputs a light source control signal LCS for driving the light source driving part 600 to the light source driving part 600. In an exemplary embodiment, as shown in FIG. 12, the panel control signal includes the load signal TP, the vertical start signal STV, the first gate clock signal CPV1 and the second gate clock signal CPV2.

In an exemplary embodiment, as shown in FIG. 12, the timing control part 800 provides the panel driving part 400 with the first gate clock signal CPV1 and the second gate clock signal CPV2, which increase an interval between rising edges of gate signals adjacent to each other as the distance between the gate line that receives the gate signal and a data driving part 410 that outputs a data signal increases.

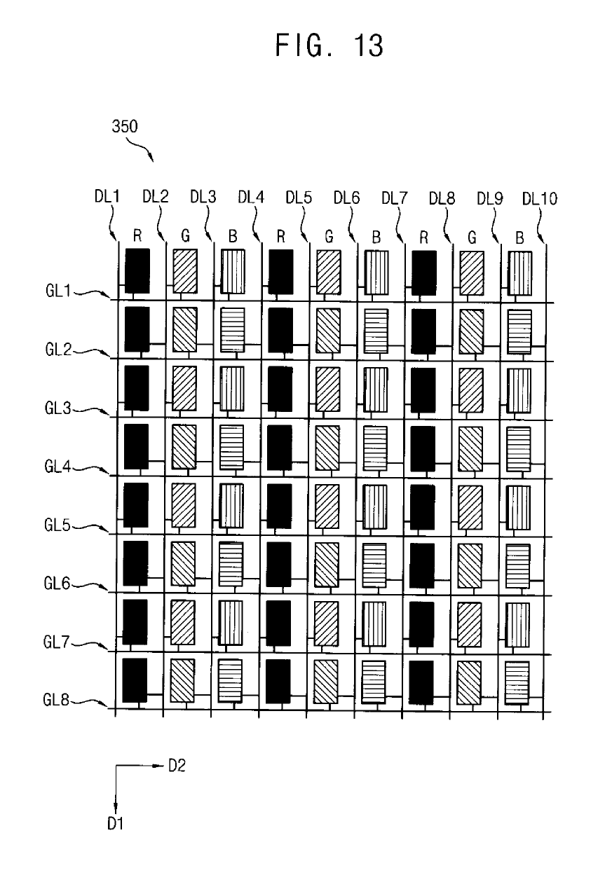

The liquid crystal display panel 350 includes first to n-th data lines DL1 to DLn, first to m-th gate lines GL1 to GLm and a plurality of pixels P. Here, ‘n’ and ‘m’ are natural numbers. Each of the pixels P includes a switching element TR connected to a corresponding data line and a corresponding gate line thereof, a liquid crystal capacitor CLC having a first terminal connected to the switching element TR and a storage capacitor CST having a first terminal connected to the switching element TR. A common electrode voltage Vcom is applied to a second terminal of the liquid crystal capacitor CLC, and a storage voltage VST is applied to a second terminal of the storage capacitor CST. In an exemplary embodiment, the liquid crystal display panel 350 may have a non-staggered arrangement, which will be described in detailed with reference to FIG. 13.

The panel driving part 400 includes a data driving part 410 and a gate driving part 430. The panel driving part 400 sequentially outputs a left-eye image, a refresh image, a right-eye image and the refresh image to the liquid crystal display panel 350 using the received data. In an exemplary embodiment, the refresh image may be a black image for increasing contrast ratio of an image. In an alternative exemplary embodiment, the refresh image may be a white image for increasing a brightness of an image in a low power. Hereinafter, for convenience of description, an exemplary embodiment where the refresh image is a black image will be described.

The data driving part 410 outputs a data voltage of the left-eye data frame to the liquid crystal display panel 350 during a first period, and blocks the data voltage from being provided to the liquid crystal display panel 350 during a second period, as described in FIG. 2. The data driving part 410 outputs a black data voltage to the liquid crystal display panel 350 during the second based on a control of the timing control part 200, as described in FIG. 2. In such an embodiment, as described in FIG. 2, the data driving part 410 outputs a data voltage of the right-eye data frame to the liquid crystal display panel 350 during a third period, and blocks the data voltage from being provided to the liquid crystal display panel 350 during a fourth period, as described in FIG. 2. The data driving part 410 outputs a black data voltage to the liquid crystal display panel 350 during the fourth period based on the control of the timing control part 200.

The gate driving part 430 provides the gate lines GL1 to GLm of the liquid crystal display panel 350 with gate signals based on a gate-on voltage Von and a gate-off voltage Voff that are provided from the voltage generating part 250. In an exemplary embodiment, as shown in FIG. 12, the gate driving part 430 outputs a plurality of gate signals G1 to Gm to the liquid crystal display panel 350 based on the first gate clock signal CPV1 and the second gate clock signal CPV2 that are provided from the timing control part 800, such that an interval between rising edges of gate signals G1 to Gm is increased as a distance between the gate line that receives the gate signal and the data driving part 410 increases.

In FIG. 12, the liquid crystal display panel 350 may be a panel configured to be driven by low frequency. In such an embodiment, when the liquid crystal display panel 350 is driven by high frequency, a gradual blank frame insertion is adapted when a 3D image is displayed such that a pixel-charging rate may be increased. In such an embodiment, a pre-charging interval is maintained equal to or greater than one horizontal period 1H by pre-charging a previous data signal in a current pixel, such that a pixel-charging rate corresponding to the current pixel is effectively increased.

In an exemplary embodiment, an interval between rising edges of gate signals adjacent to each other is increased as the gate signals are moving away from the data driving part 410, such that a loss of a pixel-charging rate generated by RC delay may be compensated. In one exemplary embodiment, for example, when the liquid crystal display panel 350 may be configured to be driven at a frequency of about 120 Hz. In such an embodiment, the liquid crystal display panel 350 may be driven at a frequency of about 120 Hz when the liquid crystal display panel is in a 2D mode, and the liquid crystal display panel 350 may be driven at a frequency of about 240 Hz when the liquid crystal display panel is in a 3D mode.

FIG. 13 is a block diagram showing an exemplary embodiment of the liquid crystal display panel of FIG. 12. In one exemplary embodiment, for example, a liquid crystal display panel having a staggered arrangement, as shown in FIG. 13. In the liquid crystal display panel of the staggered arrangement, pixels adjacent to each other in a column direction are connected to data lines different from each other. For convenience of description, an exemplary embodiment, where a liquid crystal display panel has a pixel structure of 9×8, will hereinafter be described.

Referring to FIG. 13, the liquid crystal display panel 350 includes first to tenth data lines DL1 to DL10, first to eighth gate lines GL1 to GL8 and a plurality of pixels. For convenience of description, an exemplary embodiment, where eight gate lines, nine data lines and seventy-two pixels are disposed on the liquid crystal display panel 350, will be described, but the invention is not limited thereto or thereby.

The first to tenth data lines DL1 to DL10 extend substantially in a first direction D1 and are arranged substantially in a second direction D2 crossing the first direction D1. In FIG. 13, the first direction D1 may correspond with a column direction, and the second direction D2 may correspond to a row direction.

The first to eighth gate lines GL1 to GL8 extend substantially in the second direction D2 and are arranged substantially in the first direction D1.

Each of the pixels may include a switching element (not shown) connected to a corresponding gate line and a corresponding data line thereof, a liquid crystal capacitor (not shown) connected to the switching element and a storage capacitor (not shown) connected to the switching element.

In an exemplary embodiment, a pixel corresponding to an odd-numbered row of an odd-numbered column is connected to an odd-numbered data line and an odd-numbered gate line, and a pixel corresponding to an even-numbered row of an odd-numbered column is connected to an even-numbered data line and an even-numbered gate line. A pixel corresponding to an odd-numbered row of an even-numbered column is connected to an even-numbered data line and an odd-numbered gate line, and a pixel corresponding to an even-numbered row of an even-numbered column is connected to an odd-numbered data line and an even-numbered gate line.

In one exemplary embodiment, for example, a pixel corresponding to a first row of a first column is connected to the first data line DL1 and the first gate line GL1, and a pixel corresponding to a second row of the first column is connected to the second data line DL2 and the second gate line GL2. A pixel corresponding to a third row of the first column is connected to the first data line DL1 and the third gate line GL3, and a pixel corresponding to a fourth row of the first column is connected to the second data line DL2 and the fourth gate line GL4.

A pixel corresponding to the first row of a second column is connected to the second data line DL2 and the first gate line GL1, and a pixel corresponding to the second row of the second column is connected to the third data line DL3 and the second gate line GL2. A pixel corresponding to the third row of the second column is connected to the second data line DL2 and the third gate line GL3, and a pixel corresponding to the fourth row of the second column is connected to the third data line DL3 and the fourth gate line GL4.

In a similar manner, a pixel corresponding to a sixth row of a fifth column is connected to the sixth data line DL6 and the sixth gate line GL6, and a pixel corresponding to a seventh row of the fifth column is connected to the fifth data line DL5 and the seventh gate line GL7.

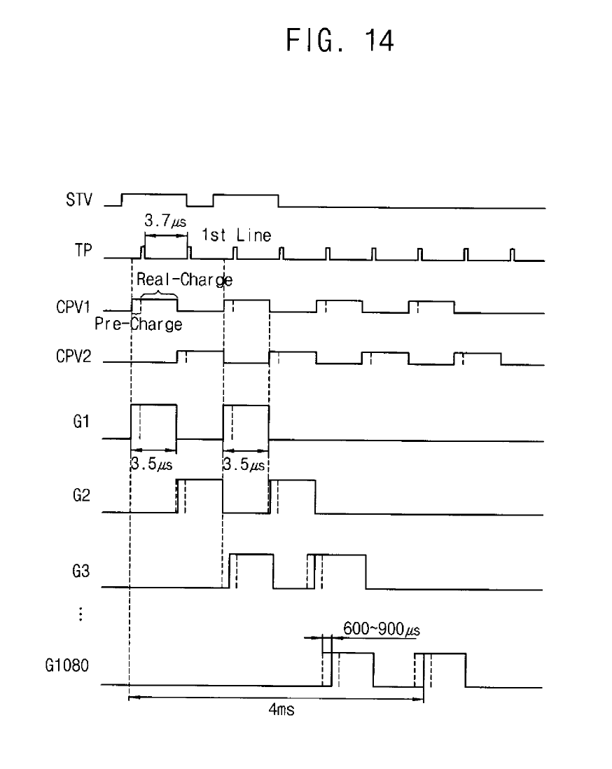

FIG. 14 is a signal timing diagram showing an exemplary embodiment of driving signals of the liquid crystal display apparatus in FIG. 12.

Referring to FIG. 14, the vertical start signal STV that indicates a start of an image frame is applied to the gate driving part 430, and then the first clock signal CPV1 and the second gate clock signal CPV2 are sequentially applied to the gate driving part 430. In an exemplary embodiment, the vertical start signal STV may include two pulses. A first pulse of the two pulses of the vertical start signal STV activates an outputting of an even-numbered gate signal, and a second pulse of the two pulses of the vertical start signal STV activates an outputting of an odd-numbered gate signal. In an exemplary embodiment, the first gate clock signal CPV1 and the second gate clock signal CPV2 does not overlap each other.

The period of each of the first and second gate clock signals CPV1 and CPV2 includes a pre-charging period and a main-charging period. During the pre-charging period, a gate signal is transited from a low level to a high level to charge a data signal corresponding to an (n−1)-th gate line in an n-th pixel corresponding to an n-th gate line. The main-charging period is determined based on the load signal TP. The load signal TP is a signal which loads a data signal to the data line in one horizontal period 1H.

The first gate clock signal CPV1 is outputted to generate an (n−1)-th gate signal, and the second gate clock signal CPV2 is outputted to generate an n-th gate signal. Here, ‘n’ is a natural number greater than or equal to 2.

In an exemplary embodiment, each of the first and second gate clock signals CPV1 and CPV2 has a rising edge gradually delayed with respect to a vertical synchronization signal STV. In such an embodiment, a first gate signal G1 has a normal rising edge, and a second gate signal G2 has a rising edge delayed by a first interval from the rising edge of the first gate signal G1. Therefore, in an exemplary embodiment where the number of gate lines is 1,080, a (1080)-th gate signal G1080 applied to the last gate line may have a rising edge delayed by about 600 μs to about 900 μs from a rising edge of the first gate signal G1.

As described above, in an exemplary embodiment, a data signal corresponding to an (n−1)-th gate signal Gn−1 is pre-charged in an n-th pixel and an outputting of a gate signal is gradually shifted as the distance between the gate line that receives the gate signal and a lower area of a liquid crystal display panel decreases, such that a charging rate of the n-th pixel is effectively compensated. In such an embodiment, a data signal corresponding a previous gate signal is pre-charged in a current pixel corresponding to a current gate signal, such that a pixel-charging rate of the current pixel is substantially increased.

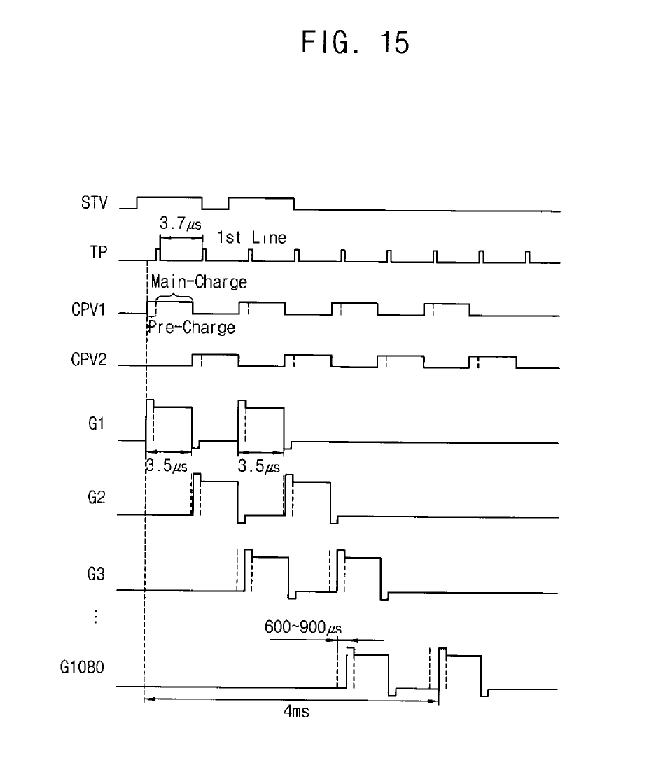

FIG. 15 is a signal timing diagram showing an alternative exemplary embodiment of the driving signals of the liquid crystal display apparatus in FIG. 12.

Referring to FIG. 15, the vertical start signal STV is applied to the gate driving part 430, and then the first clock signal CPV1 and the second gate clock signal CPV2 are sequentially applied to the gate driving part 430. In an exemplary embodiment, as shown in FIG. 15, the vertical start signal STV includes two pulses. A first pulse of the two pulses of the vertical start signal STV activates an outputting of an even-numbered gate signal, and a second pulse of the two pulses of the vertical start signal STV activates an outputting of an odd-numbered gate signal. In an exemplary embodiment, the first gate clock signal CPV1 and the second gate clock signal CPV2 does not overlap each other.

The period of each of the first and second gate clock signals CPV1 and CPV2 includes a pre-charging period and a main-charging period. During the pre-charging period, a gate signal is transited from a low level to a high level to charge a data signal corresponding to an (n−1)-th gate line in an n-th pixel corresponding to an n-th gate line. The main-charging period is determined based on the load signal TP. The load signal TP is a signal which loads a data signal to the data line in one horizontal period 1H.

The first gate clock signal CPV1 is outputted to generate an (n−1)-th gate signal, and the second gate clock signal CPV2 is outputted to generate an n-th gate signal. Here, ‘n’ is a natural number greater than or equal to 2.

In an exemplary embodiment, each of the first and second gate clock signals CPV1 and CPV2 has a rising edge gradually delayed with respect to a vertical synchronization signal STV. In such an embodiment, a first gate signal G1 has a normal rising edge, and a second gate signal G2 has a rising edge delayed by a first interval from the rising edge of the first gate signal G1. Therefore, in an exemplary embodiment where the number of gate lines is 1,080, the (1080)-th gate signal G1080 applied to the last gate line may have a rising edge delayed by about 600 μs to about 900 μs with respect to a rising edge of the first gate signal G1.

In an exemplary embodiment, as show in FIG. 15, each rising edge of gate signals are overshot, and each falling edge of gate signals are undershot. In an alternative exemplary embodiment, each of the gate signals may be overshot in only rising edges of the gate signals. In another alternative exemplary embodiment, each of the gate signals may be undershot in only falling edges of the gate signals. When the gate signals are overshot (or undershot), charging operation and/or discharging operation of pixels may be accelerated. The overshooting or undershooting of the gate signals may be provided by the gate driving part 430.

As described above, in an exemplary embodiment, a data signal corresponding to an (n−1)-th gate signal Gn−1 is pre-charged in an n-th pixel, thereby compensating a charging rate of the n-th pixel. In such an embodiment, a data signal corresponding a previous gate signal is pre-charged in a current pixel corresponding to a current gate signal, such that a charging rate of the current pixel is substantially increased.

In such an embodiment, an outputting of a gate signal is gradually shifted as the distance between the gate line that receives the gate signal and a lower area of a liquid crystal display panel decreases, thereby effectively compensating a charging rate of the n-th pixel. In such an embodiment, when a pixel corresponding to an n-th gate line is charged, a data charged in a pixel corresponding to an (n−2)-th gate line is pre-charged in the pixel corresponding to the n-th gate line, such that a horizontal line defect is effectively prevented.

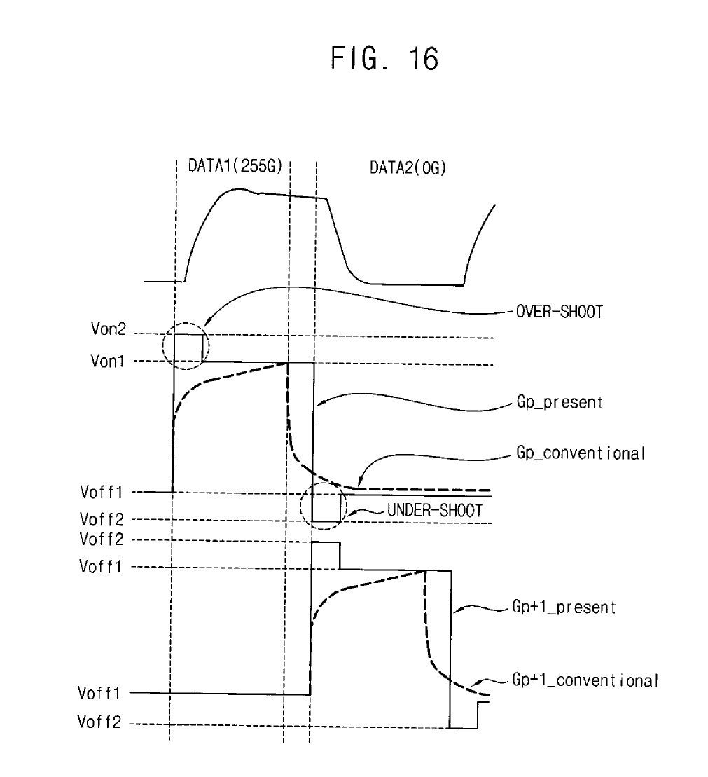

FIG. 16 is a waveform diagram showing an exemplary embodiment of a gate signal having an overshoot and an undershoot described in the liquid crystal display apparatus of FIG. 15. In FIG. 16, a waveform shown in a dotted line represents a conventional gate signal, and a waveform shown in a solid line represents an exemplary embodiment of a gate signal having an overshooting and an undershooting according to the invention. In FIG. 16, the reference numeral “Voff1” represents a turn-off level of a conventional gate signal (hereinafter, a first gate-off voltage), and the reference numeral “Von1” represents a turn-on level of a conventional gate signal (hereinafter, a first gate-on voltage). In FIG. 16, the reference numeral “Von2” represents an overshooting level of a gate signal (hereinafter, a second gate-on voltage), and the reference numeral “Voff2” represents an undershooting level of a gate signal (hereinafter, a second gate-off voltage). In an exemplary embodiment, the first gate-on voltage Von1 may be about 32 V, and the second gate-on voltage Von2 may be about 35 V. In such an embodiment, the first gate-off voltage Voff1 may be about −7 V, and the second gate-off voltage Voff2 may be about −12 V.

Referring to FIG. 16, in an exemplary embodiment, a first data signal DATA1 outputted from a data driving part has 255-grayscale level, and a second data signal DATA2 has 0-grayscale level. In such an embodiment, the first data signal DATA1 may be charged in an (n−1)-th pixel and the second data signal DATA2 may be charged in an n-th pixel. In such an embodiment, the first and second data signals DATA1 and DATA2 may be applied to a same data line.

In such an embodiment, the first gate signal is overshot in correspondence with a rising edge of the first data signal DATA1 in the (n−1)-th pixel, and is undershot in correspondence with a falling edge of the first data signal DATA1 in the (n−1)-th pixel, when a voltage corresponding to the first data signal DATA1 is charged in the (n−1)-th pixel.

In such an embodiment, a first switching element corresponding to an (n−1)-th pixel which charges the first data signal DATA1 is turned on substantially faster due to the overshot gate signal. Thus, the first data signal DATA1 may be charged in an (n−1)-th pixel connected to the first switching element with an increased speed.

In such an embodiment, the first switching element corresponding to an (n−1)-th pixel which charges the first data signal DATA1 is turned off substantially faster due to the undershot gate signal. Thus, the second data signal DATA2 may be charged in the n-th pixel through a second switching element corresponding to an n-th pixel. In such an embodiment, since the first switching element corresponding to the (n−1)-th pixel maintains a turn-off state during the second data signal DATA2 is applied to a data line, the second data signal DATA2 may be delivered to an n-th pixel only through the second switching element without charged in the (n−1)-th pixel through the first switching element.

As described above, in an exemplary embodiment according to the invention, an interval between rising edges of gate signals adjacent to each other is increased as the distance between the gate line that receives the gate signal and a data driving part increases, such that a loss of a pixel-charging rate due to RC delay is effectively compensated, and a luminance of a 3D image is thereby substantially enhanced.

In an exemplary embodiment, a pre-charging interval is maintained to be equal to or greater than 1H by pre-charging a previous data signal or a next previous data signal, such that a pixel-charging rate corresponding to a current pixel is increased, and a luminance of a 3D image is thereby improved.

In an exemplary embodiment, a refresh image, such as a black image or a white image, is inserted between a left-eye image and a right-eye image, such that a crosstalk of the 3D image is effectively prevented.

In an exemplary embodiment, an outputting of a gate signal is gradually shifted as the distance between the gate line that receives the gate signal and a lower area of a liquid crystal display panel decreases, such that a charging rate of a pixel is effectively compensated.

In an exemplary embodiment, when a pixel corresponding to an n-th gate line is charged, a data to be charged in a pixel corresponding to an (n−2)-th gate line is pre-charged in the pixel corresponding to the n-th gate line, such that a horizontal line defect is effectively prevented.

The foregoing is illustrative of the invention and is not to be construed as limiting thereof. Although a few exemplary embodiments of the invention are described herein, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a liquid crystal display panel comprising a liquid crystal cell connected to a data line and a gate line, the method comprising:
outputting a data signal to the data line;
outputting a plurality of gate clock signals; and
outputting a gate signal to the gate line based on the gate clock signals, wherein an interval between rising edges of the gate signals adjacent to each other is increased as a distance between the liquid crystal cell receiving the gate signal and a data driving part outputting the data signal increases.

2. The method of claim 1, wherein the outputting the data signal to the data line comprises:
outputting one of a left-eye data signal and a right-eye data signal to the data line during a first interval of a first sub-frame;
outputting a refresh data signal to the data line during a second interval of the first sub-frame;
outputting the remaining of the left-eye data signal and the right-eye data signal to the data line during a first interval of a second sub-frame; and
outputting the refresh data signal to the data line during a second interval of the second sub-frame.

3. The method of claim 2, wherein
a maintaining interval of the left-eye data signal is gradually decreased as a distance between the liquid crystal cell receiving the left-eye data signal and the data driving part increases, and
a maintaining interval of the refresh data signal is gradually increased as a distance between the liquid crystal cell receiving the refresh data signal and the data driving part increases.

4. The method of claim 2, wherein
a maintaining interval of the right-eye data signal is gradually decreased as a distance between the liquid crystal cell receiving the right-eye data signal and the data driving part increases, and
a maintaining interval of the refresh data signal is gradually increased as a distance between the liquid crystal cell receiving the refresh data signal and the data driving part increases.

5. The method of claim 2, wherein the refresh data signal is a black data signal or a white data signal.

6. The method of claim 1, wherein the outputting the data signal to the data line comprises:
outputting the data signal to the data line during a first interval of a first sub-frame; and
outputting a refresh data signal to the data line during a second interval of the first sub-frame.

7. The method of claim 6, wherein
a maintaining interval of the data signal is gradually decreased as a distance between the liquid crystal cell receiving the data signal and the data driving part increases, and
a maintaining interval of the refresh data signal is gradually increased as a distance between the liquid crystal cell receiving the refresh data signal, and the data driving part increases.

8. The method of claim 1, wherein
the gate clock signals comprise a first gate clock signal and a second gate clock signal,
a period of each of the first and second gate clock signals comprises a pre-charging period and a main-charging period,
a gate signal corresponding to an (n−1)-th gate line is generated based on the first gate clock signal,
a gate signal corresponding to an n-th gate line is generated based on the second gate clock signal,
the gate signals generated based on each of the first and second gate clock signals are transited from a low level to a high level during the pre-charging period such that a data signal corresponding to the (n−1)-th gate line is changed in a pixel corresponding to the n-th gate line during the pre-charging period, and
n is a natural number greater than or equal to 2.

9. The method of claim 8, wherein
the gate clock signals further comprise a third gate clock signal,
a period of the third gate clock signals comprises a pre-charging period and a main-charging period,
a gate signal corresponding to an (n−2)-th gate line is generated based on the first gate clock signal,
the gate signals generated based on the third gate clock signal are transited from a low level to a high level during the pre-charging period such that a data signal corresponding to the (n−2)-th gate line is changed in a pixel corresponding to the n-th gate line during the pre-charging period, and
n is a natural number greater than or equal to 3.

10. The method of claim 1, wherein
the gate clock signals comprise a first gate clock signal and a second gate clock signal,
a period of each of the first and second gate clock signals comprises a pre-charging period and a main-charging period,
a gate signal corresponding to an (n−1)-th gate line is generated based on the first gate clock signal,
a gate signal corresponding to an n-th gate line is generated based on the second gate clock signal,
the gate signals generated based on each of the first and second gate clock signals are transited from a low level to a high level during the pre-charging period such that a data signal corresponding to the (n−1)-th gate line is charged in a pixel corresponding to the n-th gate line during the pre-charging period,
each rising edge of the gate signals is overshot, and
n is a natural number greater than or equal to 2.

11. The method of claim 10, wherein
the gate clock signals further comprise a third gate clock signal,
a period of the third gate clock signal comprises a pre-charging period and a main-charging period,
a gate signal corresponding to an (n−2)-th gate line is generated based on the third gate clock signal,
the gate signals generated based on the third gate clock signal are transited from a low level to a high level during the pre-charging period such that a data signal corresponding to the (n−2)-th gate line is changed in a pixel corresponding to the n-th gate line during the pre-charging period,
each rising edge of the gate signals is overshot, and
n is a natural number greater than or equal to 3.

12. The method of claim 10, wherein each falling edge of the gate signals is undershot.

13. A liquid crystal display apparatus comprising:
a liquid crystal display panel comprising a liquid crystal cell connected to a data line and a gate line;
a data driving part configured to output a data signal to the data line;
a gate driving part configured to output a gate signal to the gate line; and
a timing control part configured to output a plurality of gate clock signals increasing an interval between rising edges of gate signals adjacent to each other as a distance between the liquid crystal cell receiving the gate signal and the data driving part increases to the gate driving part.

14. The liquid crystal display apparatus of claim 13, wherein the liquid crystal display panel has a non-staggered arrangement in which pixels adjacent to each other in a column direction are connected to the same data line.

15. The liquid crystal display apparatus of claim 14, wherein
the timing control part outputs a first gate clock signal, a second gate clock signal and a third gate clock signal to the gate driving part,
a period of each of the first to third gate clock signals comprises a pre-charging period and a main-charging period,
a gate signal corresponding to an (n−2)-th gate line is generated based on the first gate clock signal,
a gate signal corresponding to an (n−1)-th gate line is generated based on the second gate clock signal,
a gate signal corresponding to an n-th gate line is generated based on the third gate clock signal,
the gate signals generated based on each of the first to third gate clock signals are transited from a low level to a high level during the pre-charging period such that a data signal corresponding to the (n−1)-th gate line and a data signal corresponding to the (n−2)-th gate line are charged in an n-th pixel corresponding to the n-th gate line during the pre-charging period, and
n is a natural number greater than or equal to 3.

16. The liquid crystal display apparatus of claim 15, wherein an interval between a rising edge of the second gate clock signal and a rising edge of the third gate clock signal is greater than an interval between a rising edge of the first gate clock signal and a rising edge of the second gate clock signal.

17. The liquid crystal display apparatus of claim 14, wherein
the timing control part outputs a first gate clock signal, a second gate clock signal and a third gate clock signal to the gate driving part,
a period of each of the first to third gate clock signals comprises a pre-charging period and a main-charging period,
a gate signal corresponding to an (n−2)-th gate line is generated based on the first gate clock,
a gate signal corresponding to an (n−1)-th gate line is generated based on the second gate clock signal,
a gate signal corresponding to an n-th gate line is generated based on the third gate clock signal,
the gate signals generated based on each of the first to third gate clock signals are transited from a low level to a high level during the pre-charging period such that a data signal corresponding to the (n−1)-th gate line and a data signal corresponding to the (n−2)-th gate line are charged in a pixel corresponding to the n-th gate line during the pre-charging period,
each rising edge of the gate signals is overshot, and
n is a natural number greater than or equal to 3.

18. The liquid crystal display apparatus of claim 17, wherein each falling edge of the gate signals is undershot.

19. The liquid crystal display apparatus of claim 18, further comprising:
a voltage generating part which generates a first gate-on voltage, a second gate-on voltage higher than the first gate-on voltage, a first gate-off voltage and a second gate-off voltage lower than the first gate-off voltage,
wherein each rising edge of the gate signals is overshot and each falling edge of the gate signal is undershot using the first gate-on voltage, the second gate-on voltage, the first gate-off voltage and the second gate-off voltage.

20. The liquid crystal display apparatus of claim 17, wherein an interval between a rising edge of the second gate clock signal and a rising edge of the third gate clock signal is greater than an interval between a rising edge of the first gate clock signal and a rising edge of the second gate clock signal.

21. The liquid crystal display apparatus of claim 13, wherein the liquid crystal display panel has a staggered arrangement in which pixels adjacent to each other in a column direction are connected to data lines different from each other.

22. The liquid crystal display apparatus of claim 21, wherein
the timing control part outputs a first gate clock signal and a second gate clock,
a period of each of the first and second gate clock signals comprises a pre-charging period and a main-charging period,
a gate signal corresponding to an (n−1)-th gate line is generated based on the first gate clock signal,
a gate signal corresponding to an n-th gate line is generated based on the second gate clock signal,
the gate signals generated based on each of the first and second gate clock signals are transited from a low level to a high level during the pre-charging period such that a data signal corresponding to the (n−1)-th gate line is charged in a pixel corresponding to the n-th gate line during the pre-charging period, and
n is a natural number greater than or equal to 2.

23. The liquid crystal display apparatus of claim 22, wherein each of the first and second gate clock signals has a rising edge gradually delayed with respect to a vertical synchronization signal.

24. The liquid crystal display apparatus of claim 21, wherein
the timing control part outputs a first gate clock signal and a second gate clock,
a period of each of the first and second gate clock signals comprises a pre-charging period and a main-charging period,
a gate signal corresponding to an (n−1)-th gate line is generated based on the first gate clock signal,
a gate signal corresponding to an n-th gate line is generated based on the second gate clock signal,
the gate signals generated based on each of the first and second gate clock signals are transited from a low level to a high level during the pre-charging period such that a data signal corresponding to the (n−1)-th gate line is charged in a pixel corresponding to the n-th gate line during the pre-charging period,
each rising edge of the gate signals is overshot, and
n is a natural number greater than or equal to 2.

25. The liquid crystal display apparatus of claim 24, wherein each falling edge of the gate signals is undershot.

26. The liquid crystal display apparatus of claim 25, further comprising:
a voltage generating part which generates a first gate-on voltage, a second gate-on voltage higher than the first gate-on voltage, a first gate-off voltage and a second gate-off voltage lower than the first gate-off voltage,
wherein each rising edge of the gate signals is overshot and each falling edge of the gate signal is undershot using the first gate-on voltage, the second gate-on voltage, the first gate-off voltage and the second gate-off voltage.

27. The liquid crystal display apparatus of claim 24, wherein each of the first and second gate clock signals has a rising edge gradually delayed with respect to a vertical synchronization signal.
